(19) United States
(12) Patent Application Publication
(10) Pub. No.: US 2006/0187922 A1
(43) Pub. Date: Aug. 24, 2006

(54) Packet communication device

(75) Inventors: Takashi Sumiyoshi, Kokubunji (JP); Toshiaki Suzuki, Kunitachi (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/337,048

(22) Filed: Jan. 23, 2006

(30) Foreign Application Priority Data
Feb. 21, 2005 (JP) 2005-43732

(51) Int. Cl. H04L 12/56

(52) U.S. Cl. 370/389

(57) ABSTRACT

To provide a packet communication device to which a function can be added by a functional module and that realizes high throughput and low apparatus cost. According to this invention, there is provided a packet communication device that receives a packet and transfers the packet received in a network, the packet communication device including: a network interface for transmitting the packet to and receiving the packet from the network; a path retrieving unit for judging a transfer order on the basis of the received packet and giving an identifier indicating the transfer order judged to the packet; a functional module interface to which a functional module that applies predetermined processing to the packet is connected; a module management unit for managing the functional module; and a switch for connecting the network interface and the functional module interface.

### CLAIM OF PRIORITY

The present application claims priority from Japanese patent application P2005-43732 filed on Feb. 21, 2005, the content of which is hereby incorporated by reference into this application.

### BACKGROUND OF THE INVENTION

The present invention relates to a packet communication device for transferring packet data, in particular, a technique for routing and switching in layers above a layer 2 of an OSI reference model.

In recent years, Internet Protocol (IP) packet communication is widely used in the Internet and in-house networks. There are various needs for a network for packet communication. For example, there are needs for introduction of new value added services in the network, measures against an increase of network users, and highly reliable communication that is required because the network has become indispensable for daily life.

Therefore, a packet communication device that transfers a packet on the network is required to have function multiplicity, performance extensibility, and high reliability.

A packet communication device that meets these requirements is disclosed in JP 2004-289223 A. The packet communication device is provided with an interface for extending a functional module providing an additional function.

The conventional packet communication device judges processing necessary for a packet received from a network interface and determines a transfer path according to the processing determined. Subsequently, the conventional packet communication device adds addresses of all functional modules present on the transfer path determined to the packet as an internal header section. Then, the functional module connected to the packet communication device determines a transfer destination of the packet by referring to the internal header section given to the packet.

### SUMMARY OF THE INVENTION

However, in the conventional packet communication device, an amount of data in the internal header section given to the packet is large. Therefore, there has been a problem in that throughput is reduced.

In the conventional packet communication device, the internal header section given to the packet is variable length data. Therefore, there has been a problem in that processing for removing the internal header section given to the packet using the functional module is complicated.

The conventional packet communication device has to hold information on the variable length internal header section. Thus, there has been a problem in that it is impossible to efficiently use a memory.

Further, there has been a problem in that the functional module connected to the conventional packet communication device needs to include a processing unit that processes the internal header section of the packet. Thus, processing cost and product cost are large.

It is an object of this invention to provide a packet communication device that solves these problems.

According to this invention, there is provided a packet communication device that receives a packet and transfers the packet received in a network, the packet communication device includes: a network interface that transmits the packet to and receives the packet from the network; a path retrieving unit that judges a transfer order, based on which the received packet is transferred in the packet communication device, on the basis of the received packet and gives an identifier indicating the transfer order judged to the packet; a functional module interface to which a functional module that applies predetermined processing to the packet is connected; a module management unit that manages the functional module; and a switch that connects the network interface and the functional module interface.

According to this invention, the following effects are realized.

(1) It is possible to minimize an amount of data in the internal header section given to the packet. Therefore, it is possible to improve throughput of the packet communication device.

(2) Since the internal header section given to the packet has a fixed length, the functional module can easily extract a section excluding the internal header section of the packet. Therefore, it is possible to reduce mounting cost and processing cost for the packet communication device.

(3) The internal header section given to the packet has a fixed length. Therefore, it is possible to efficiently use the memory that holds the internal header information. The number of entries of the path table that can be supported by an identical quantity of a memory is improved.

(4) The internal transfer processing unit is mounted on the functional module interface that is the basic section of the packet communication device. Therefore, since it is unnecessary to mount the internal transfer processing unit on each of the functional modules, it is possible to create the functional modules at low cost.

### BRIEF DESCRIPTION OF THE DRAWINGS

The present invention can be appreciated by the description which follows in conjunction with the following figures, wherein:

FIG. 1 is a block diagram of a packet communication device according to a first embodiment of this invention;

FIG; 2 is a diagram of a flow definition table of a module control management unit according to the first embodiment of this invention.

FIG. 3 is a diagram of a path table of a path retrieving unit according to the first embodiment of this invention;

FIG. 4 is a diagram of an internal transfer destination table of a functional module according to the first embodiment of this invention;

FIG. 5 is a diagram of the internal transfer destination table of the functional module according to the first embodiment of this invention;

FIG. 6 is a flowchart of path processing by the module control management unit according to the first embodiment of this invention;

FIG. 7 is a flowchart of packet transfer processing by a network interface according to the first embodiment of this invention;

FIG. 8 is a flowchart of packet processing by the functional module according to the first embodiment of this invention;

FIG. 9 is a diagram for explaining packet transfer processing by the packet communication device according to the first embodiment of this invention;

FIG. 10 is a block diagram of a packet communication device according to a second embodiment of this invention;

FIG. 11 is a flowchart of packet transfer processing by a functional module interface that receives a packet from a functional module according to the second embodiment of this invention;

FIG. 12 is a diagram for explaining packet transfer processing by the packet communication device according to the second embodiment of this invention;

FIG. 13 is a diagram of a flow definition table of a module control management unit according to a third embodiment of this invention;

FIG. 14 is a diagram of an internal transfer destination table of a functional module according to the third embodiment of this invention;

FIG. 15 is a diagram of the internal transfer destination table of the functional module according to the third embodiment of this invention;

FIG. 16 is a flowchart of packet processing by the functional module according to the third embodiment of this invention;

FIG. 17 is a diagram for explaining packet transfer processing by a packet communication device according to the third embodiment of this invention;

FIG. 18 is a block diagram of a packet communication device according to a fourth embodiment of this invention;

FIG. 19 is a diagram of a path table of a path retrieving unit according to the fourth embodiment of this invention;

FIG. 20 is a flowchart of packet transfer processing by a network interface according to the fourth embodiment of this invention;

FIG. 21 is a diagram for explaining a packet inside the packet communication device according to the fourth embodiment of this invention;

FIG. 22 is a flowchart of packet transfer processing by a functional module interface that receives a packet from a functional module according to the fourth embodiment of this invention;

FIG. 23 is a diagram for explaining packet transfer processing by the packet communication device according to the fourth embodiment of this invention;

FIG. 24 is a diagram for explaining a packet inside a packet communication device according to a fifth embodiment of this invention;

FIG. 25 is a flowchart of packet transfer processing by a functional module interface that receives a packet from a functional module according to the fifth embodiment of this invention;

FIG. 26 is a diagram for explaining packet transfer processing by the packet communication device according to the fifth embodiment of this invention;

FIG. 27 is a diagram of an internal transfer destination table of a functional module according to a sixth embodiment of this invention;

FIG. 28 is a diagram of the internal transfer destination table of the functional module according to the sixth embodiment of this invention;

FIG. 29 is a flowchart of processing for creating an internal transfer destination table of a module control management unit according to the sixth embodiment of this invention;

FIG. 30 is a flowchart of packet processing by the functional module according to the sixth embodiment of this invention;

FIG. 31 is a diagram for explaining packet transfer processing by a packet communication device according to the sixth embodiment of this invention;

FIG. 32 is a block diagram of a packet communication device according to a seventh embodiment of this invention;

FIG. 33 is a diagram of a flow definition table of a module control management unit according to the seventh embodiment of this invention;

FIG. 34 is a diagram of an internal transfer destination table of a functional module according to the seventh embodiment of this invention;

FIG. 35 is a diagram of the internal transfer destination table of the functional module according to the seventh embodiment of this invention;

FIG. 36 is a flowchart of packet processing by the functional module according to the seventh embodiment of this invention;

FIG. 37 is a block diagram of a packet communication device according to the seventh embodiment of this invention;

FIG. 38 is a diagram of a path table of a path retrieving unit according to an eighth embodiment of this invention;

FIG. 39 is a flowchart of packet transfer processing by a network interface according to the eighth embodiment of this invention;

FIG. 40 is a diagram of a packet inside the packet communication device according to the eighth embodiment of this invention; and

FIG. 41 is a diagram of the packet inside the packet communication device according to the eighth embodiment of this invention.

### DESCRIPTION OF THE PREFERRED EMBODIMENTS

Embodiments of this invention will be hereinafter explained with reference to the accompanying drawings.

### First Embodiment

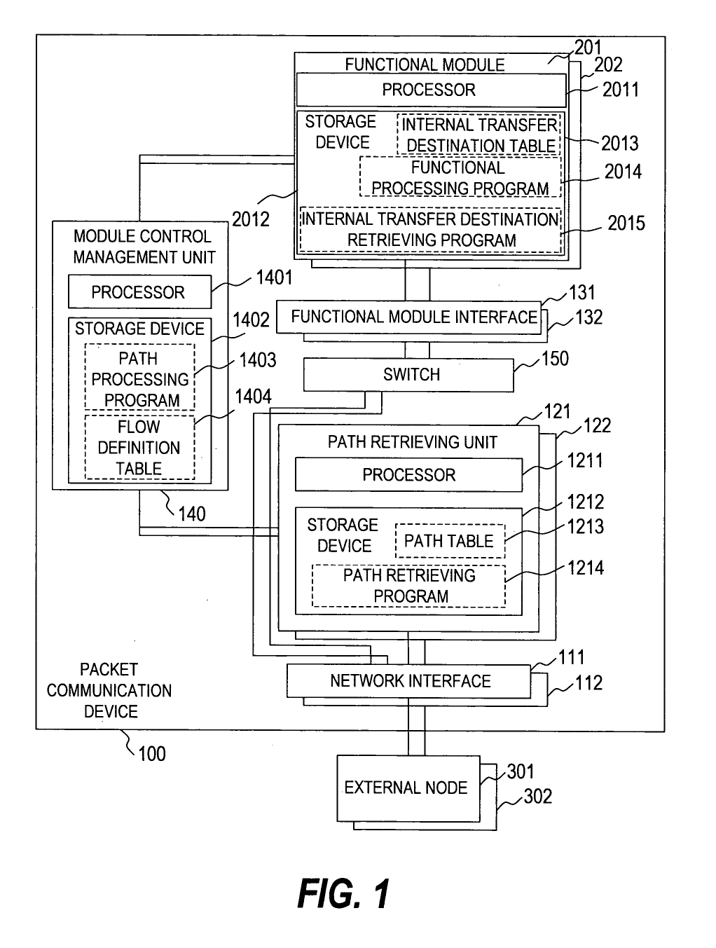

FIG. 1 is a block diagram of a packet communication device 100 according to a first embodiment of this invention.

The packet communication device 100 includes network interfaces 111 and 112, path retrieving units 121 and 122, functional module interfaces 131 and 132, functional modules 201 and 202, a module control management unit 140, and a switch 150. The packet communication device 100 is connected to external nodes 301 and 302 to transmit and receive packets.

In the figure, the numbers of the network interfaces 111 and 112, the path retrieving unit 121 and 122, the functional module interfaces 131 and 132, and the functional modules 201 and 202 are two, respectively. The numbers may be any number.

The network interface 111 connects the switch 150 and the external node 301 to transfer a packet. The network interface 111 is connected to the path retrieving unit 121 to inquire about a path of a received packet.

Similarly, the network interface 112 connects the switch 150 and the external node 302 to transfer a packet. The network interface 112 is connected to the path retrieving unit 122 to inquire about a path of a received packet.

All the network interfaces 111 and 112 may be connected to one of the path retrieving units 121 and 122.

The path retrieving units 121 and 122 include processors 1211 and storage devices 1212. The processors 1211 execute programs stored in the storage devices 1212 to thereby perform various kinds of processing. Path tables 1213 and path retrieving programs 1214 are stored in the storage devices 1212.

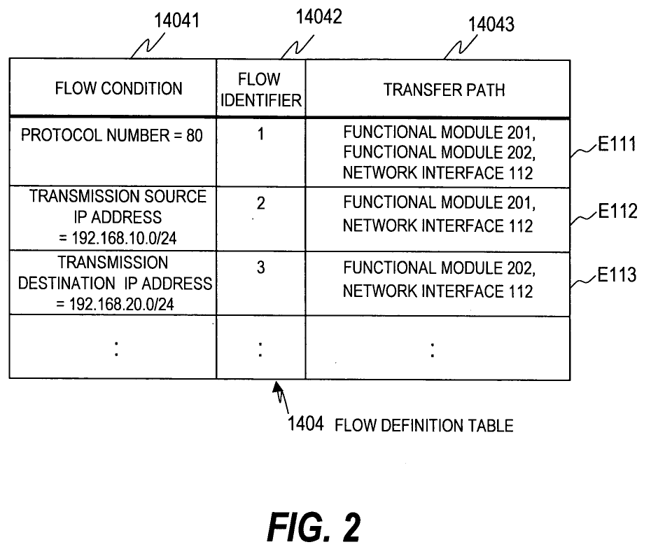

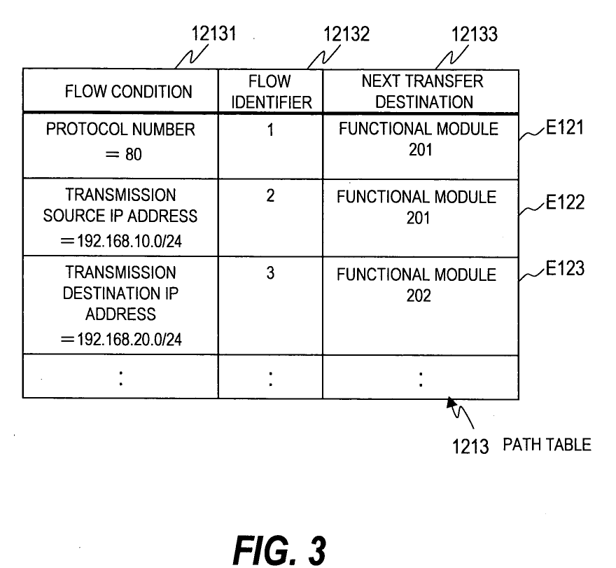

The path tables 1213 indicate transfer paths of packets received by the network interfaces 111 and 112. The path tables 1213 are described later with reference to FIG. 3. The path retrieving programs 1214 retrieve, from the path tables 1213, the transfer paths of the packets received by the network interfaces 111 and 112.

The network interfaces 111 and 112 and the path retrieving units 121 and 122 may be included in one device.

The switch 150 is connected to the network interfaces 111 and 112 and the functional module interfaces 131 and 132. When the switch 150 receives a packet, the switch 150 transfers the packet to a destination stored in a header section of the packet received.

The packet communication device 100 does not have to include the switch 150. In this case, the network interfaces 111 and 112 and the functional module interfaces 131 and 132 are directly connected to each other.

The functional module interface 131 connects the switch 150 and the functional module 201 to transfer a packet. Similarly, the functional module interface 132 connects the switch 150 and the functional module 202 to transfer a packet.

The packet communication device 100 does not have to include the functional module interfaces 131 and 132. In this case, the functional modules 201 and 202 and the switch 150 are directly connected to each other.

The functional modules 201 and 202 include processors 2011 and storage devices 2012. The processors 2011 execute programs stored in the storage devices 2012 to thereby perform various kinds of processing. Internal transfer destination tables 2013, functional processing programs 2014, and internal transfer destination retrieving programs 2015 are stored in the storage devices 2012.

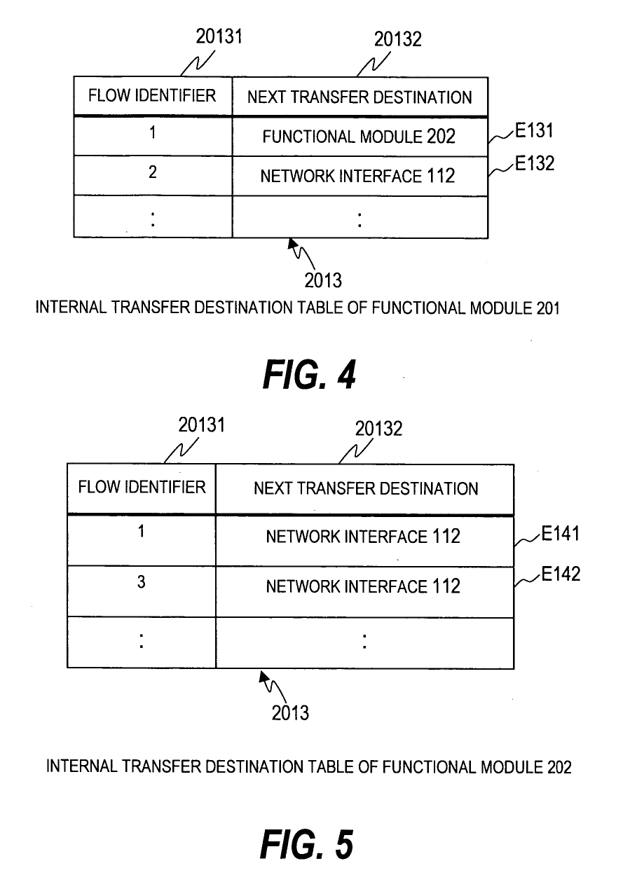

The internal transfer destination tables 2013 indicate transfer destinations of packets received by the functional modules 201 and 202. The internal transfer destination tables 2013 are described later with reference to FIG. 4. The functional processing programs 2014 apply various kinds of processing to the packets received by the functional modules 201 and 202. The various kinds of processing are, for example, statistical processing, routing processing, encryption processing, virus check processing, and/or firewall processing. The internal transfer destination retrieving programs 2015 retrieve, from the internal transfer destination tables 2013, transfer destinations of packets received by the functional modules 201 and 202.

The functional modules 201 and 202 may be provided outside the packet communication device 100. In this case, it is possible to replace the functional modules 201 and 202 according to processing for received packets.

The module control management unit 140 is connected to the path retrieving units 121 and 122 and the functional modules 201 and 202. The module control management unit 140 includes a processor 1401 and a storage device 1402. The processor 1401 executes a program stored in the storage device 1402 to thereby perform various kinds of processing.

A path processing program 1403 and a flow definition table 1404 are stored in the storage device 1402.

The flow definition table 1404 indicates a transfer path of a packet received by the packet communication device 100. The flow definition table 1404 is described later with reference to FIG. 3. The path processing program 1403 creates the path tables 1213 of the path retrieving units 121 and 122 and the internal transfer destination table 2013 of the functional modules 201 and 202.

The module control management unit 140 may are connected to the switch 150 without being connected to the path retrieving units 121 and 122 and the functional modules 201 and 202. In this case, the module control management unit 140 accesses the path retrieving units 121 and 122 and the functional modules 201 and 202 via the switch 150.

FIG. 2 is a diagram of the flow definition table 1404 of the module control management unit 140 according to the first embodiment of this invention.

The flow definition table 1404 includes a flow condition 14041, a flow identifier 14042, and a transfer path 14043.

The flow condition 14041 is a condition for judging a transfer path of packets received by the network interfaces 111 and 112. For example, a protocol number of the packet, a TCP port number, a transmission source IP address, a transmission destination IP address, a transmission source MAC address, a transmission destination MAC address, and/or identifiers of the network interfaces 111 and 112 that receive the packet are stored in the flow condition 14041.

The flow identifier 14042 is an identifier for uniquely identifying a transfer path of the packet.

The transfer path 14043 is a path for transferring the packet. Hardware identifiers of apparatuses to which the packet is transferred are stored in the transfer path 14043 from the head in an order of transfer. The hardware identifiers are identifiers for uniquely identifying the network interfaces 111 and 112, the functional modules 201 and 202, and the like.

For example, a packet with a protocol number “80” coincides with an entry E111 with the flow condition 14041 “protocol number=80”. Therefore, the packet is transferred to the functional module 201, the functional module 202, and the network interface 112 in this order.

Similarly, a packet with a transmission source IP address “192.168.10.0/24” is transferred to the functional module 201 and the network interface 112 in this order (an entry E112). A packet with a transmission destination IP address “192.168.20.0/24” is transferred to the functional module 202 and the network interface 112 in this order (an entry E113).

FIG. 3 is a diagram of the path table 1213 of the path retrieving units 121 and 122 according to the first embodiment of this invention.

The path table 1213 includes a flow condition 12131, a flow identifier 12132, and a next transfer destination 12133. The path table 1213 is created in association with the flow definition table 1404. Thus, the path table 1213 and the flow definition table 1404 have an identical number of entries.

The flow condition 12131 is a condition for judging a transfer path of packets received by the network interfaces 111 and 112. Information identical with the flow condition 14041 of the flow definition table 1404 as shown in FIG. 2 described above is stored in the flow condition 12131.

The flow identifier 12132 is an identifier for uniquely identifying a transfer path of the packet.

Hardware identifiers of apparatuses to which the network interfaces 111 and 112, which receive the packets, transfer the packets next are stored in a next transfer destination 12133.

FIG. 4 is a diagram of the internal transfer destination table 2013 of the functional module 201 according to the first embodiment of this invention.

The internal transfer destination table 2013 of the functional module 201 includes a flow identifier 20131 and a next transfer destination 20132.

The flow identifier 20131 is an identifier for uniquely identifying a transfer path of a packet.

Hardware identifiers of apparatuses to which the functional module 201, which receives the packets, transfers the packet next are stored in the next transfer destination 20132.

FIG. 5 is a diagram of the internal transfer destination table 2013 of the functional module 202 according to the first embodiment of this invention;

The internal transfer destination table 2013 of the functional module 202 has components identical with those of the internal transfer destination table as shown in FIG. 4 of the functional module 201 described above. Thus, an explanation of the internal transfer destination table 2013 is omitted.

Hardware identifiers of apparatuses to which the functional module 202 transfers the packet next are stored in the next transfer destination 20132.

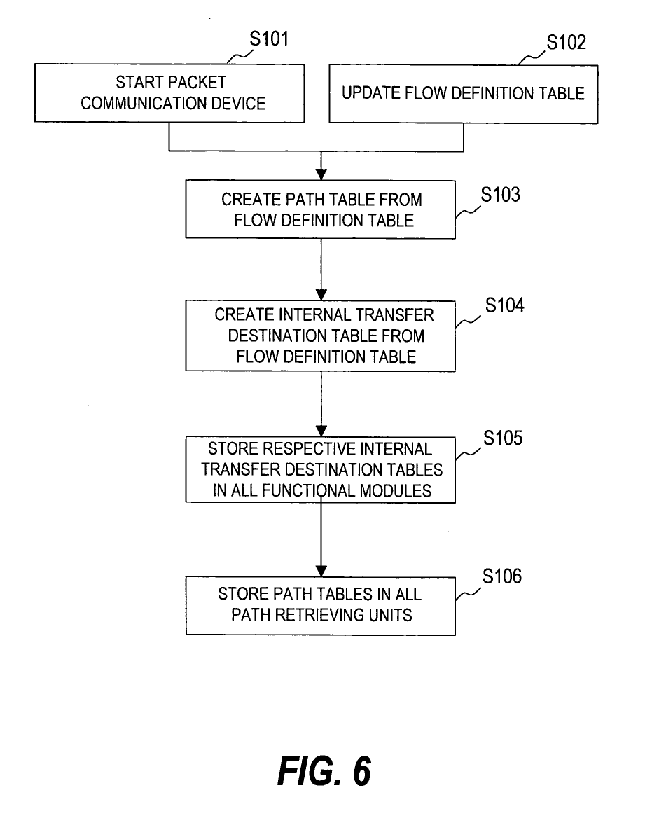

FIG. 6 is a flowchart of path processing of the module control management unit 140 according to the first embodiment of this invention.

When the packet communication device 100 is started (S101), the module control management unit 140 starts the path processing. When an administrator changes the flow definition table 1404 (S102), the module control management unit 140 also starts the path processing.

First, the module control management unit 140 creates the path table 1213 based on the flow definition table 1404 (S103).

Specifically, the module control management unit 140 selects the entries of the flow definition table 1404 one by one from the head. The module control management unit 140 creates an entry of the path table 1213 based on the entries selected as described below.

The module control management unit 140 stores the flow condition 14041 of the selected entry in the flow condition 12131 of the path table 1213. Subsequently, the module control management unit 140 stores the flow identifier 14042 in the flow identifier 12132 of the path table 1213. Subsequently, the module control management unit 140 stores hardware identifiers stored at the head of the transfer path 14043 of the selected entry in the next transfer destination 12133 of the path table 1213.

For example, the module control management unit 140 creates the path table 1213 shown in FIG. 3 based on the flow definition table 1404 shown in FIG. 2.

Specifically, the module control management unit 140 creates an entry E121 of the path table 1213 based on the entry E111 of the flow definition table 1404. Similarly, the module control management unit 140 creates an entry E122 of the path table 1213 based on the entry E112 of the flow definition table 1404. The module control management unit 140 creates an entry E123 of the path table 1213 based on the entry E113 of the flow definition table 1404.

Subsequently, the module control management unit 140 creates the internal transfer destination table 2013 based on the flow definition table 1404 (S104). The module control management unit 140 creates the different internal transfer destination table 2013 for each of the functional modules 201 and 202.

Here, creation of the internal transfer destination tables 2013 of the functional modules 201 and 202 identified hardware identifiers X are explained as an example.

First, the module control management unit 140 retrieves the hardware identifiers X from the transfer path 14043 of the flow definition table 1404. Then, the module control management unit 140 creates one entry of the internal transfer destination table 2013 based on one of the hardware identifiers X retrieved.

Specifically, the module control management unit 140 extracts the flow identifier 14042 of an entry in which the hardware identifier X retrieved is stored from the flow definition table 1404. Subsequently, the module control management unit 140 stores the flow identifier 14042 extracted in the flow identifier 20131 of the internal transfer destination table 2013. The module control management unit 140 extracts a hardware identifier stored right below the retrieved hardware identifier X from the transfer path 14043 of the flow definition table 1404. The module control management unit 140 stores the hardware identifier extracted in the next transfer destination 20132 of the internal transfer destination table 2013.

For example, the module control management unit 140 creates the internal transfer table 2013 of the functional module 201 shown in FIG. 4 based on the flow definition table 1404 having the content shown in FIG. 2. Specifically, the module control management unit 140 creates an entry E131 of the internal transfer destination table 2013 based on the entry E111 of the flow definition table 1404. The module control management unit 140 creates an entry E132 of the internal transfer destination table 2013 based on the entry E112 of the flow definition table 1404.

The module control management unit 140 creates the internal transfer destination table 2013 of the functional module 202 shown in FIG. 5 based on the flow definition table 1404 having the content shown in FIG. 2. Specifically, the module control management unit 140 creates an entry E141 of the internal transfer destination table 2013 based on the entry E111 of the flow definition table 1404. The module control management unit 140 creates an entry E142 of the internal transfer destination table 2013 based on the entry E113 of the flow definition table 1404.

Subsequently, the module control management unit 140 stores the internal transfer destination table 2013 created in the functional modules 201 and 202 corresponding to the internal transfer destination table 2013 (S105). The module control management unit 140 stores the path table 1213 created in all the path retrieving units 121 and 122 (S106).

As described above, the module control management unit 140 updates the internal transfer destination table 2013 and the path table 1213.

Step S104 may be performed before step S103. Similarly, step S106 may be performed before step S105.

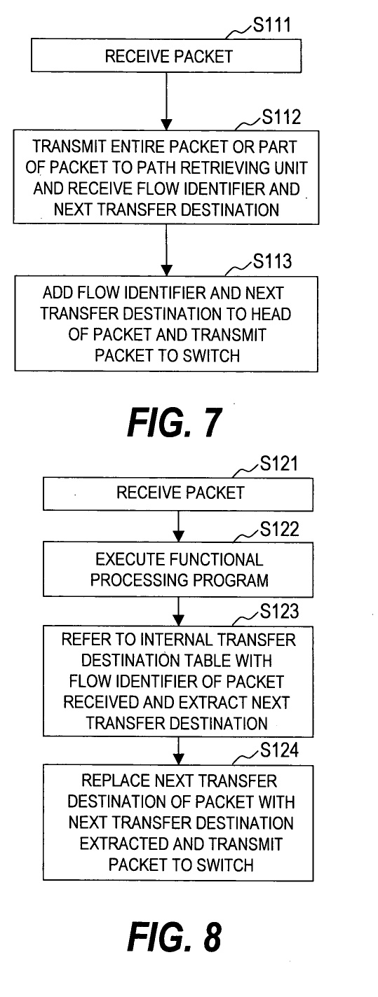

FIG. 7 is a flowchart of packet transfer processing of the network interface 111 according to the first embodiment of this invention.

First, the network interface 111 receives a packet from the external node 301 (S111).

Subsequently, the network interface 111 transmits the entire packet or a part of the packet received to the path retrieving unit 121. A section for judging a path of the packet (e.g., header section) has to be included in a part of the packet.

The path retrieving unit 121 retrieves an entry in which the received packet corresponds to the flow condition 12131 from the path table 1213. Subsequently, the path retrieving unit 121 extracts the flow identifier 12132 and the next transfer destination 12133 from the entry retrieved. The path retrieving unit 121 transmits the flow identifiers 12132 and the next transfer destination 12133 extracted to the network interface 111.

The network interface 111 receives the flow identifier 12132 and the next transfer destination 12133 (S112).

Subsequently, the network interface 111 adds the flow identifier 12132 and the next transfer destination 12133 received to the head of the packet received from the external node 301 as an internal header section. The network interface 111 transmits the packet added with the internal header section to the switch 150 (S113).

FIG. 8 is a flowchart of packet processing of the functional module 201 according to the first embodiment of this invention.

First, the functional module 201 receives a packet from the functional module interface 131 (S121). Subsequently, the functional module 201 executes the functional processing program 2014 to thereby apply predetermined processing to the packet received (S122).

Subsequently, the functional module 201 extracts a flow identifier added to the received packet. The functional module 201 selects, from the internal transfer destination table 2013, an entry in which the flow identifier extracted and the flow identifier 20131 of the internal transfer destination table 2013 coincide with each other. The functional module 201 extracts the next transfer destination 20132 of the entry selected (S123).

Subsequently, the functional module 201 replaces a next transfer destination added to the received packet with the next transfer destination 20132 extracted. The functional module 201 transmits the packet to the switch 150 via the functional module interface 131 (S124).

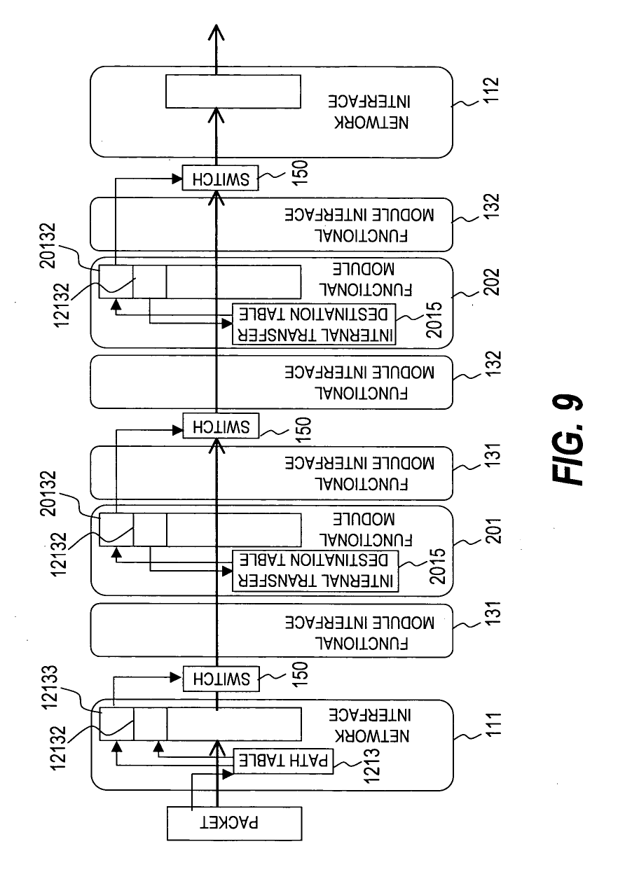

FIG. 9 is a diagram for explaining packet transfer processing of the packet communication device 100 according to the first embodiment of this invention.

First, the network interface 111 receives a packet from the external node 301. In this explanation, a protocol number of the packet received is “80”.

Subsequently, the network interface 111 transmits a header section of the received packet to the path retrieving unit 121. The path retrieving unit 121 retrieves an entry in which the header section received corresponds to the flow condition 12131 of the path table 1213 from the path table 1213.

Subsequently, the path retrieving unit 121 extracts the flow identifier 12132 and the next transfer destination 12133 from the entry retrieved. The path retrieving unit 121 transmits the flow identifier 12132 and the next transfer destination 12133 extracted to the network interface 111.

Specifically, since the protocol number of the packet is “80”, the path retrieving unit 121 retrieves the entry E121 from the path table 1213. The path retrieving unit 121 extracts “1” of the flow identifier 12132 and the “functional module 201” of the next transfer destination 12133 from the entry E121 The path retrieving unit 121 transmits “1” of the flow identifier 12132 and the “functional module 201” of the next transfer destination 12133 to the network interface 111.

The network interface 111 adds the flow identifier 12132 and the next transfer destination 12133 received to the packet. The network interface 111 transmits the packet to the switch 150.

The switch 150 extracts the next transfer destination 12133 from the packet received. The switch 150 transfers the received packet to an interface of an apparatus corresponding to the next transfer destination 12133 extracted.

Specifically, the switch 150 extracts the “functional module 201” of the next transfer destination 12133 from the packet received. The switch 150 transfers the received packet to the functional module interface 131 to which the “functional module 201” of the next transfer destination 12133 extracted is connected.

The functional module interface 131 transfers the packet received from the switch 150 to the functional module 201 to which the functional module interface 131 is connected.

The functional module 201 receives a packet from the functional module interface 131. Subsequently, the functional module 201 executes the functional processing program 2014 to thereby apply predetermined processing to the packet received.

Subsequently, the functional module 201 extracts the flow identifier 12132 added to the received packet. The functional module 201 retrieves, from the internal transfer destination table 2013 of the functional module 201, an entry in which the flow identifier 12132 extracted and the flow identifier 20131 of the internal transfer destination table 2013 coincide with each other. The functional module 201 extracts the next transfer destination 20132 from the entry retrieved. The functional module 201 replaces the next transfer destination 12133 added to the received packet with the next transfer destination 20132 extracted.

Specifically, the functional module 201 extracts “1” of the flow identifier 12132 added to the received packet. Subsequently, the functional module 201 retrieves, from the internal transfer destination table 2013, the entry E131 in which “1” of the flow identifier 12132 extracted and the flow identifier 20131 coincide with each other. The functional module 201 extracts the “functional module 202” of the next transfer destination 20132 from the entry E131 retrieved.

The functional module 201 replaces the “functional module 201” of the next transfer destination 12133 added to the received packet with the “functional module 202” of the next transfer destination 20132 extracted.

The functional module 201 transmits the packet to the functional module interface 131 to which the functional module 201 is connected.

The functional module interface 131 transfers the packet received to the switch 150.

The switch 150 transfers the packet in the same manner as the processing at the time when the switch 150 receives the packet from the network interface 111.

Specifically, the switch 150 extracts the “functional module 202” of the next transfer destination 20132 from the packet received. The switch 150 transfers the received packet to the functional module interface 132 to which the “functional module 202” of the next transfer destination 20132 extracted is connected.

The functional module interface 132 transfers the packet received from the switch 150 to the functional module 202 to which the functional module interface 132 is connected.

The functional module 202 processes the packet in the same manner as the processing performed by the functional module 201.

Specifically, the functional module 202 executes the functional processing program 2014 to thereby apply predetermined processing to the packet received. Subsequently, the functional module 202 extracts “1” of the flow identifier 12132 added to the received packet.

Subsequently, the functional module 202 retrieves, from the internal transfer destination table 2013, an entry E141 in which “1” of the flow identifier 12132 extracted and the flow identifier 20131 coincide with each other. The functional module 202 extracts the “network interface 112” of the next transfer destination 20132 from the entry E141 retrieved.

The functional module 202 replaces the “functional module 202” of the next transfer destination 12133 added to the received packet with the “network interface 112” of the next transfer destination 20132 extracted.

The functional module 202 transmits the packet to the functional module interface 132 to which the functional module 202 is connected.

The functional module interface 132 transfers the packet received to the switch 150.

The switch 150 transfers the packet in the same manner as the processing at the time when the switch 150 receives the packet from the network interface 111.

Specifically, the switch 150 extracts the “network interface 112” of the next transfer destination 20132 from the packet received. The switch 150 transfers the received packet to the “network interface 112” of the next transfer destination 20132 extracted.

The network interface 112 receives the packet from the switch 150. Subsequently, the network interface 112 removes the flow identifier 12132 and the next transfer destination 20132 from the packet received.

The network interface 112 transmits the packet, from which the flow identifier 121132 and the next transfer destination 20132 are removed, to the external node 302 to which the network interface 112 is connected.

As described above, the packet communication device 100 transfers the packet.

The packet communication device 100 in this embodiment adds only two pieces of information, a flow identifier and a next transfer destination, to a packet. In other words, the packet communication device 100 minimizes an amount of data of an internal header section to be added to the packet. Consequently, since an amount of traffic inside the packet communication device 100 is reduced, the packet communication device 100 can improve throughput.

The packet communication device 100 in this embodiment adds a fixed length internal header section to a packet. This facilitates processing of a functional module for removing the internal header section added to the packet.

Since the packet communication device 100 in this embodiment holds information on the fixed length internal header section, the packet communication device 100 can use a memory efficiently.

### Second Embodiment

In a second embodiment of this invention, the functional module interfaces 131 and 132 judge a transfer destination.

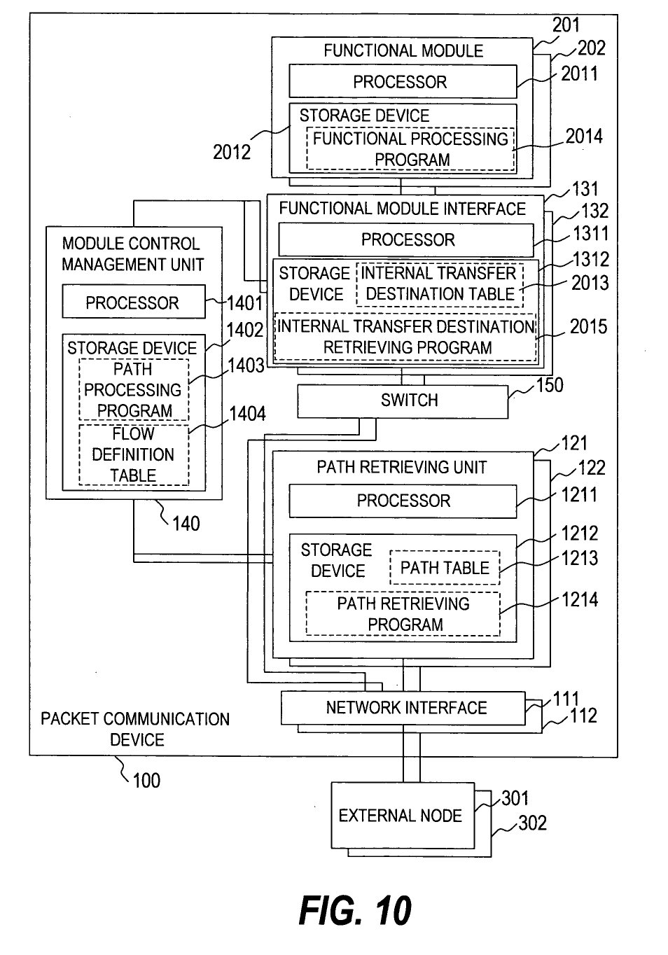

FIG. 10 is a block diagram of a packet communication device 100 according to a second embodiment of this invention.

The packet communication device 100 in the second embodiment has a constitution identical with that of the packet communication device in the first embodiment as shown in FIG. 1 except the points described below. Components identical with those in the first embodiment are denoted by the identical reference symbols. Explanations of the components are omitted.

A first difference is components included in the functional module interfaces 131 and 132. The functional module interfaces 131 and 132 in this embodiment include processors 1311 and storage devices 1312.

The processors 1311 execute programs stored in the storage devices 1312 to thereby perform various kinds of processing.

The internal transfer destination tables 2013 as shown in FIG. 4 and the internal transfer destination retrieving programs 2015 are stored in the storage devices 1312.

The internal transfer destination tables 2013 and the internal transfer destination retrieving programs 2015 are identical with those stored in the storage devices 2012 of the functional modules 201 and 202 in the first embodiment. Thus, the internal transfer destination tables 2013 and the internal transfer destination retrieving programs 2015 are not stored in the storage devices 2012 of the functional modules 201 and 202 in this embodiment.

A second difference is connection of the module control management unit 140. In this embodiment, the module control management unit 140 is not connected to the functional modules 201 and 202 but is connected to the functional module interfaces 131 and 132.

Thus, the module control management unit 140 stores the internal transfer destination table 2013 in the functional module interfaces 131 and 132 rather than the functional modules 201 and 202 in the path processing as shown in FIG. 6 in step S105. Since the other kinds of processing of the module control management unit 140 are identical with those in the first embodiment, explanations of the processing are omitted.

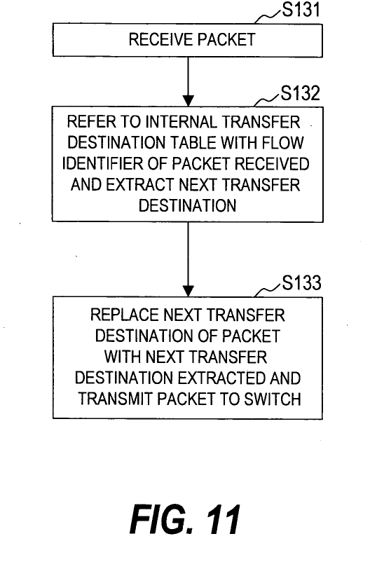

FIG. 11 is a flowchart of packet transfer processing of the functional module interface 131 that receives a packet from the functional module 201 according to the second embodiment of this invention.

First, the functional module interface 131 receives a packet from the functional module 201 (S131).

Subsequently, the functional module interface 131 extracts a flow identifier added to the packet received. The functional module interface 131 selects, from the internal transfer destination table 2013, an entry in which the flow identifier extracted and the flow identifier 20131 of the internal transfer destination table 2013 coincide with each other. The functional module interface 131 extracts the next transfer destination 20132 of the entry selected (S132).

Subsequently, the functional module interface 131 replaces a next transfer destination added to the received packet with the next transfer destination 20132 extracted. The functional module interface 131 transfers the packet to the switch 150 (S133).

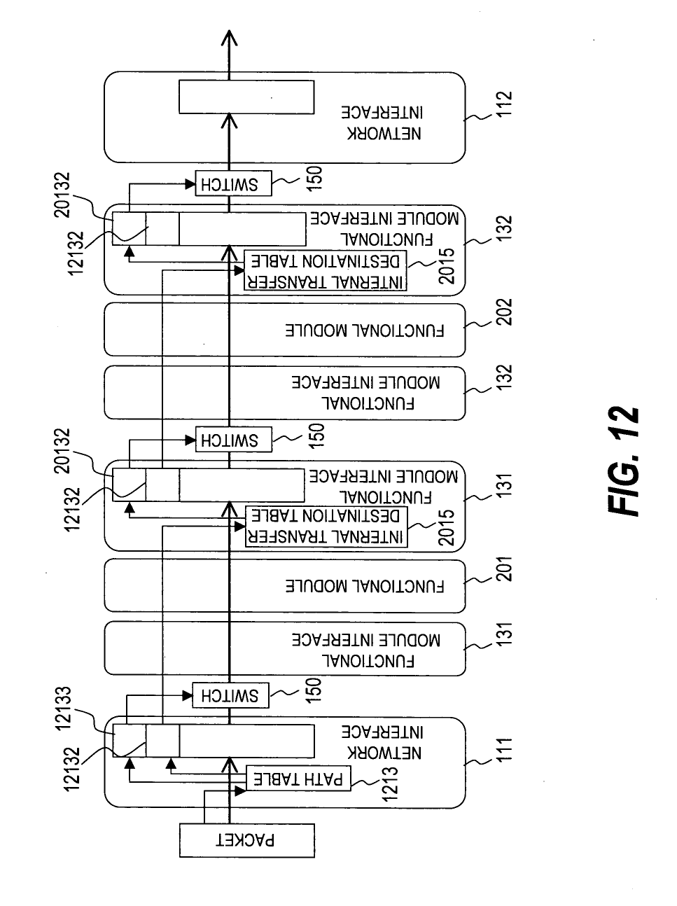

FIG. 12 is a diagram for explaining packet transfer processing of the packet communication device 100 according to the second embodiment of this invention.

The packet transfer processing of the packet communication device 100 in this embodiment is identical with the packet transfer processing as shown in FIG. 9 in the first embodiment except that the functional module interfaces 131 and 132 perform processing for judging a next transfer destination. Thus, an explanation of the identical processing is omitted and only differences will be explained.

The packet transfer processing is identical with the packet transfer processing as shown in FIG. 9 in the first embodiment until the functional module 201 applies the predetermined processing to a packet.

After applying the predetermined processing to the received packet, the functional module 201 transmits the packet to the functional module interface 131.

The functional module interface 131 receives the packet from the functional module 201. The functional module interface 131 extracts the flow identifier 12132 added to the packet received.

Subsequently, the functional module interface 131 retrieves, from the internal transfer destination table 2013 of the functional module interface 131, an entry in which the flow identifier 12132 extracted and the flow identifier 20131 of the internal transfer destination table 2013 coincide with each other. The functional module interface 131 extracts the next transfer destination 20132 from the entry retrieved.

The functional module interface 131 replaces the next transfer destination 12133 added to the received packet with the next transfer destination 20132 extracted.

The functional module interface 131 transmits the packet to the switch 150.

The packet transfer processing is identical with the packet transfer processing as shown in FIG. 9 in the first embodiment after the transmission of the packet to the switch 150 until the functional module 202 applies the predetermined processing to the packet.

After applying the predetermined processing to the received packet, the functional module 202 transmits the packet to the functional module interface 132.

The functional module interface 132 receives the packet from the functional module 202. The functional module interface 132 extracts the flow identifier 12132 added to the packet received.

Subsequently, the functional module interface 132 retrieves, from the internal transfer destination table 2013, an entry in which the flow identifier 12132 extracted and the flow identifier 20131 coincide with each other. The functional module interface 132 extracts the next transfer destination 20132 from the entry retrieved.

The functional module interface 132 replaces the next transfer destination added to the received packet with the next transfer destination 20132 extracted.

The functional module interface 132 transmits the packet to the switch 150.

The packet transfer processing is identical with the packet transfer processing as shown in FIG. 9 in the first embodiment after the transmission of the packet to the switch 150.

In the second embodiment, the functional module interfaces 131 and 132 include the internal transfer destination tables 2013 and the internal transfer destination retrieving programs 2015. In other words, the functional modules 201 and 202 do not need to include the internal transfer destination tables 2013 and the internal transfer destination retrieving programs 2015. Thus, it is possible to reduce processing of the functional modules 201 and 202. Moreover, it is possible to create the functional modules 201 and 202 at low cost.

### Third Embodiment

In a third embodiment of this invention, a counter value is added to a packet inside the packet communication device 100. This makes it possible to transfer the packet to the identical functional modules 201 and 202 plural times.

It is possible to apply the third embodiment of this invention to the packet communication device 100 in both the first embodiment and the second embodiment. In this explanation, the third embodiment is applied to the packet communication device 100 in the first embodiment.

A constitution of the packet communication device 100 in the third embodiment is identical with that of the packet communication device as shown in FIG. 1 in the first embodiment except components of the internal transfer destination table 2013 stored in the functional module 201. Thus, an explanation of the constitution of the packet communication device 100 is omitted.

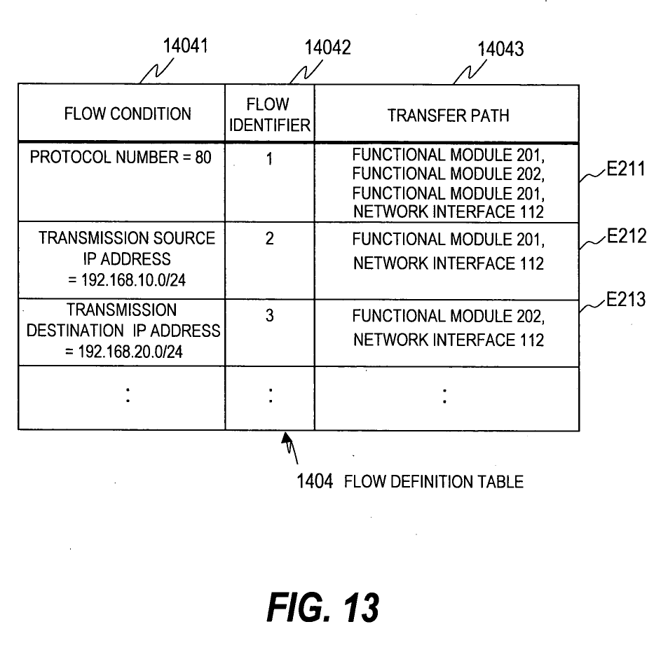

In an example explained below, the flow definition table 1404 shown in FIG. 13 is created.

FIG. 13 is a diagram of the flow definition table 1404 of the module control management unit 140 according to the third embodiment of this invention.

Components of the flow definition table 1404 in the third embodiment are identical with those of the flow definition table as shown in FIG. 2 in the first embodiment. The identical components are denoted by the identical reference symbols. Explanations of the components are omitted.

For example, a packet with a protocol number “80” is transferred to the functional module 201, the functional module 202, the functional module 201, and the network interface 112 in this order (an entry E211).

A packet with a transmission source IP address “192.168.10.0/24” is transferred to the functional module 201 and the network interface 112 in this order (an entry E212). A packet with a transmission destination IP address “192.168.20.0/24” is transferred to the functional module 202 and the network interface 112 in this order (an entry E213).

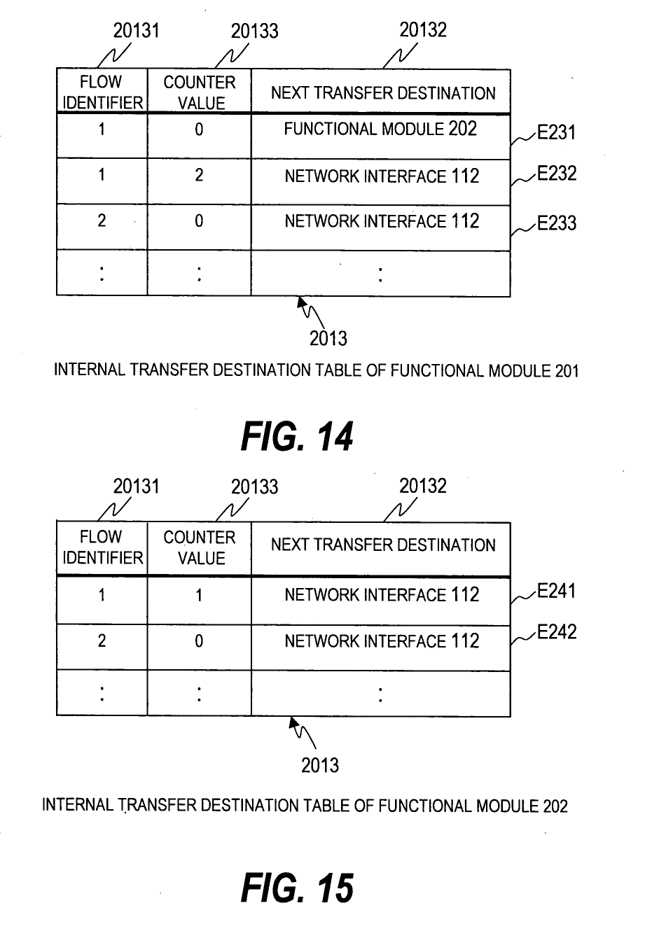

FIG. 14 is a diagram of the internal transfer destination table 2013 of the functional module 201 according to the third embodiment of this invention.

The internal transfer destination table 2013 in the third embodiment includes components identical with those in the internal transfer destination table as shown in FIG. 4 in the first embodiment. The identical components are denoted by the identical reference symbols. Explanations of the components are omitted.

The internal transfer destination table 2013 in the third embodiment further includes a counter value 20133.

The counter value 20133 is the number of times a packet passes through the functional modules 201 and 202. The functional module 201 compares the counter value 20133 with a value of a counter added to the packet.

Subsequently, the module control management unit 140 process which creates the internal transfer destination tables 2013 of the functional modules 201 and 202 identified hardware identifiers X are explained.

First, the module control management unit 140 retrieves the hardware identifiers X from the transfer path 14043 of the flow definition table 1404. Then, the module control management unit 140 creates one entry of the internal transfer destination table 2013 based on one of the hardware identifiers X retrieved.

Specifically, the module control management unit 140 extracts the flow identifier 14042 of an entry in which the hardware identifier X retrieved is stored from the flow definition table 1404. Subsequently, the module control management unit 140 stores the flow identifier 14042 extracted in the flow identifier 20131 of the internal transfer destination table 2013.

The module control management unit 140 extracts a hardware identifier stored right below the retrieved hardware identifier X from the transfer path 14043 of the flow definition table 1404. The module control management unit 140 stores the hardware identifier extracted in the next transfer destination 20132 of the internal transfer destination table 2013.

Subsequently, the module control management unit 140 selects an entry in which the retrieved hardware identifier X is stored from the flow definition table 1404. The module control management unit 140 counts, in the entry selected, the number of hardware identifiers stored on the retrieved hardware identifier X. The module control management unit 140 stores the value counted in the counter value 20133 of the internal transfer destination table 2013.

The module control management unit 140 repeats the processing described above for all the retrieved hardware identifiers X to create the internal transfer destination table 2013.

The module control management unit 140 creates the internal transfer destination table 2013 of the functional module 201 shown in FIG. 14 based on the flow definition table 1404 shown in FIG. 13.

Specifically, the module control management unit 140 creates an entry E231 or entry E232 of the internal transfer destination table 2013 based on the entry E211 of the flow definition table 1404. The module control management unit 140 creates an entry E233 of the internal transfer destination table 2013 based on the entry E212 of the flow definition table 1404.

FIG. 15 is a diagram of the internal transfer destination table 2013 of the functional module 202 according to the third embodiment of this invention.

The internal transfer destination table 2013 of the functional module 202 is identical to the internal transfer destination table of the functional module 201 as shown in FIG. 14 explained above, so explanations of the components are omitted.

The module control management unit 140 creates the internal transfer destination table 2013 of the functional module 202 shown in FIG. 14 based on the flow definition table 1404 shown in FIG. 13.

Specifically, the module control management unit 140 creates an entry E241 of the internal transfer destination table 2013 based on the entry E211 of the flow definition table 1404. The module control management unit 140 creates an entry E242 of the internal transfer destination table 2013 based on the entry E213 of the flow definition table 1404.

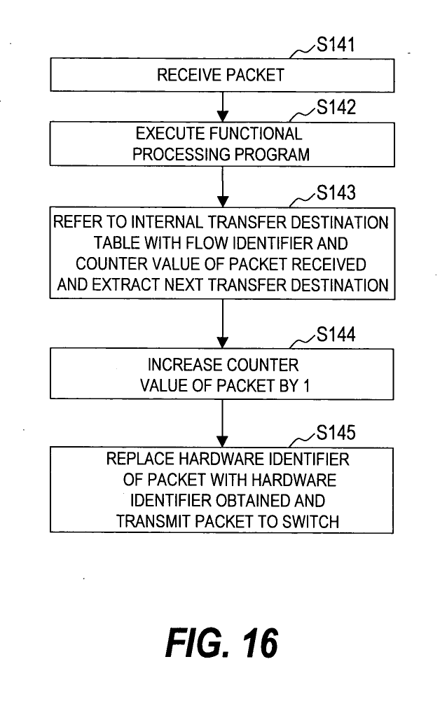

FIG. 16 is a flowchart of packet processing of the functional module 201 according to the third embodiment of this invention.

First, the functional module 201 receives a packet from the functional module interface 131 (S141).

Subsequently, the functional module 201 executes the functional processing program 2014 to thereby apply predetermined processing to the packet received (S142).

Subsequently, the functional module 201 extracts a flow identifier and a counter value added to the received packet. The functional module 201 selects, from the internal transfer destination table 2013, an entry in which the flow identifier extracted and the flow identifier 20131 of the internal transfer destination table 2013 coincide with each other and the counter value extracted and the counter value 20133 of the internal transfer destination table 2013 coincide with each other. The functional module 201 extracts the next transfer destination 20132 of the entry selected (S143).

Subsequently, the functional module 201 increases the value of the counter added to the received packet (S144).

Subsequently, the functional module 201 replaces a next transfer destination added to the received packet with the next transfer destination 20132 extracted. The functional module 201 transmits the packet to the switch 150 via the functional module interface 131 (S145).

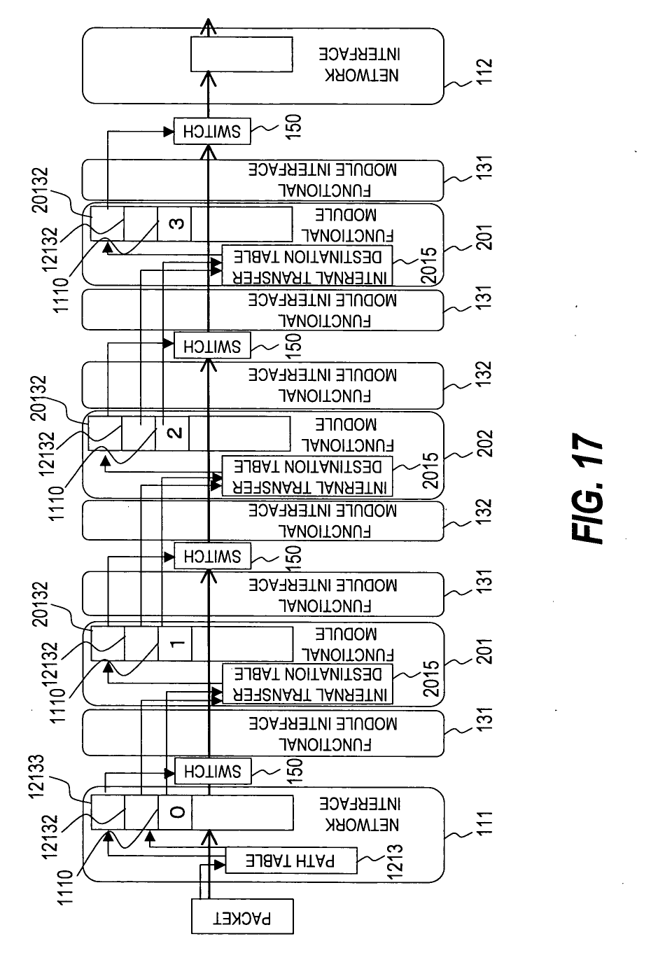

FIG. 17 is a diagram for explaining packet transfer processing of the packet communication device 100 according to the third embodiment of this invention.

First, the network interface 111 receives a packet from the external node 301. In this explanation, a protocol number of the packet received is “80”.

Subsequently, the network interface 111 transmits a header section of the received packet to the path retrieving unit 121. The path retrieving unit 121 retrieves an entry in which the header section received corresponds to the flow condition 12131 of the path table 1213 from the path table 1213 as shown in FIG. 3.

Subsequently, the path retrieving unit 121 extracts the flow identifier 12132 and the next transfer destination 12133 from the entry retrieved. The path retrieving unit 121 transmits the flow identifier 12132 and the next transfer destination 12133 extracted to the network interface 111.

Specifically, since a protocol number of the packet is “80”, the path retrieving unit 121 retrieves the entry E121 from the path table 1213. The path retrieving unit 121 extracts “1” of the flow identifier 12132 and the “functional module 201” of the next transfer destination 12133 from the entry E121. The path retrieving unit 121 transmits “1” of the flow identifier 12132 and the “functional module 201” of the next transfer destination 12133 to the network interface 111.

The network interface 111 adds the flow identifier 12132 and the next transfer destination 12133 received to the packet. The network interface 111 further adds a counter 1110, a value of which is initialized (e.g., the value is “0”), to the packet. The network interface 111 transmits the packet added with the flow identifier 12132, the next transfer destination 12133, and the counter 1110 to the switch 150.

The switch 150 extracts the next transfer destination 12133 from the packet received. The switch 150 transfers the received packet to an interface of an apparatus corresponding to the next transfer destination 12133 extracted.

Specifically, the switch 150 extracts the “functional module 201” of the next transfer destination 12133 from the packet received. The switch 150 transfers the received packet to the functional module interface 131 to which the “functional module 201” of the next transfer destination 12133 extracted is connected.

The functional module interface 131 transfers the packet received from the switch 150 to the functional module 201 to which the functional module interface 131 is connected.

The functional module 201 receives a packet from the functional module interface 131. Subsequently, the functional module 201 executes the functional processing program 2014 to thereby apply predetermined processing to the packet received.

Subsequently, the functional module 201 extracts the flow identifier 12132 and the counter value 1110 added to the received packet. The functional module 201 retrieves, from the internal transfer destination table 2013 of the functional module 201, an entry in which the flow identifier 12132 extracted and the flow identifier 20131 of the internal transfer destination table 2013 coincide with each other and the counter value 1110 extracted and the counter value 20133 of the internal transfer destination table 2013 coincide with each other.

Subsequently, the functional module 201 extracts the next transfer destination 20132 from the entry retrieved. Subsequently, the functional module 201 replaces the next transfer destination 12133 added to the received packet with the next transfer destination 20132 extracted. Further, the functional module 201 increases the value of the counter 1110 added to the received packet.

Specifically, the functional module 201 extracts “1” of the flow identifier 12132 and the value “0” of the counter 1110 added to the received packet.

Subsequently, the functional module 201 retrieves, from the internal transfer destination table 2013 of the functional module 201, an entry E231 in which “1” of the flow identifier 12132 extracted and the flow identifier 20131 of the internal transfer destination table 2013 coincide with each other and the value “0” of the counter 1110 extracted and the counter value 20133 of the internal transfer destination table 2013 coincide with each other.

Subsequently, the functional module 201 extracts the “functional module 202” of the next transfer destination 20132 of the entry E231 retrieved.

Subsequently, the functional module 201 replaces the “functional module 201” of the next transfer destination 12133 added to the received packet with the “functional module 202” of the next transfer destination 20132 extracted. The functional module 201 increases the value “0” of the counter 1110 to “1”.

The functional module 201 transmits the packet to the functional module interface 131 to which the functional module 201 is connected.

The functional module interface 131 transfers the packet received to the switch 150.

The switch 150 transfers the packet in the same manner as the processing at the time when the switch 150 receives the packet from the network interface 111.

Specifically, the switch 150 extracts the “functional module 202” of the next transfer destination 20132 from the packet received. The switch 150 transfers the received packet to the functional module interface 132 to which the “functional module 202” of the next transfer destination 20132 extracted is connected.

The functional module interface 132 transfers the packet received from the switch 150 to the functional module 202 to which the functional module interface 132 is connected.

The functional module 202 processes the packet in the same manner as the processing performed by the functional module 201 explained above.

Specifically, the functional module 202 executes the functional processing program 2014 to thereby apply predetermined processing to the packet received.

Subsequently, the functional module 202 extracts “1” of the flow identifier 12132 and the value “1” of the counter 1110 added to the received packet.

Subsequently, the functional module 202 retrieves, from the internal transfer destination table 2013 of the functional module 202, an entry E241 in which “1” of the flow identifier 12132 extracted and the flow identifier 20131 of the internal transfer destination table 2013 coincide with each other and the value “1” of the counter 1110 extracted and the counter value 20133 of the internal transfer destination table 2013 coincide with each other.

Subsequently, the functional module 202 extracts the “functional module 201” of the next transfer destination 20132 of the entry E241 retrieved.

Subsequently, the functional module 202 replaces the “functional module 202” of the next transfer destination added to the received packet with the “functional module 201” of the next transfer destination 20132 extracted. The functional module 202 increases the value “1” of the counter 1110 added to the received packet to “2”.

The functional module 202 transmits the packet to the functional module interface 132 to which the functional module 202 is connected.

The functional module interface 132 transfers the packet received to the switch 150.

The switch 150 transfers the packet in the same manner as the above-described processing at the time when the switch 150 receives the packet from the network interface 111.

Specifically, the switch 150 extracts the “functional module 201” of the next transfer destination 20132 from the packet received. The switch 150 transfers the received packet to the functional module interface 132 to which the “functional module 201” of the next transfer destination 20132 extracted is connected.

The functional module interface 131 transfers the packet received from the switch 150 to the functional module 201 to which the functional module interface 131 is connected.

As a result, the functional module 201 processes the packet in the same manner described above.

Specifically, the functional module 201 executes the functional processing program 2014 to thereby apply predetermined processing to the packet received.

Subsequently, the functional module 201 extracts “1” of the flow identifier 12132 and the value “2” of the counter 1110 added to the received packet.

Subsequently, the functional module 201 retrieves, from the internal transfer destination table 2013 of the functional module 201, an entry E232 in which “1” of the flow identifier 12132 extracted and the flow identifier 20131 of the internal transfer destination table 2013 coincide with each other and the value “2” of the counter 1110 extracted and the counter value 20133 of the internal transfer destination table 2013 coincide with each other.

Subsequently, the functional module 201 extracts the “network interface 112” of the next transfer destination 20132 of the entry E232 retrieved.

Subsequently, the functional module 201 replaces the “functional module 201” of the next transfer destination added to the received packet with the “network interface 112” of the next transfer destination 20132 extracted. The functional module 201 increases the value “2” of the counter 1110 added to the received packet to “3”.

The functional module 201 transmits the packet to the functional module interface 131 to which the functional module 201 is connected.

The functional module interface 131 transfers the packet received to the switch 150.

The switch 150 transfers the packet in the same manner as the processing when receiving the packet from the network interface 111.

Specifically, the switch 150 extracts the “network interface 112” of the next transfer destination 20132 from the packet received. The switch 150 transfers the received packet to the “network interface 112” of the next transfer destination 20132 extracted.

The network interface 112 receives the packet from the switch 150. Subsequently, the network interface 112 removes the flow identifier 12132 and the next transfer destination 20132 from the packet received.

The network interface 112 transmits the packet, from which the flow identifier and the next transfer destination are removed, to the external node 302 to which the network interface 112 is connected.

### Fourth Embodiment

In a fourth embodiment of this invention, a packet inside the packet communication device 100 includes the number of time the packet is transferred and hardware identifiers of apparatuses to which the packet is transferred.

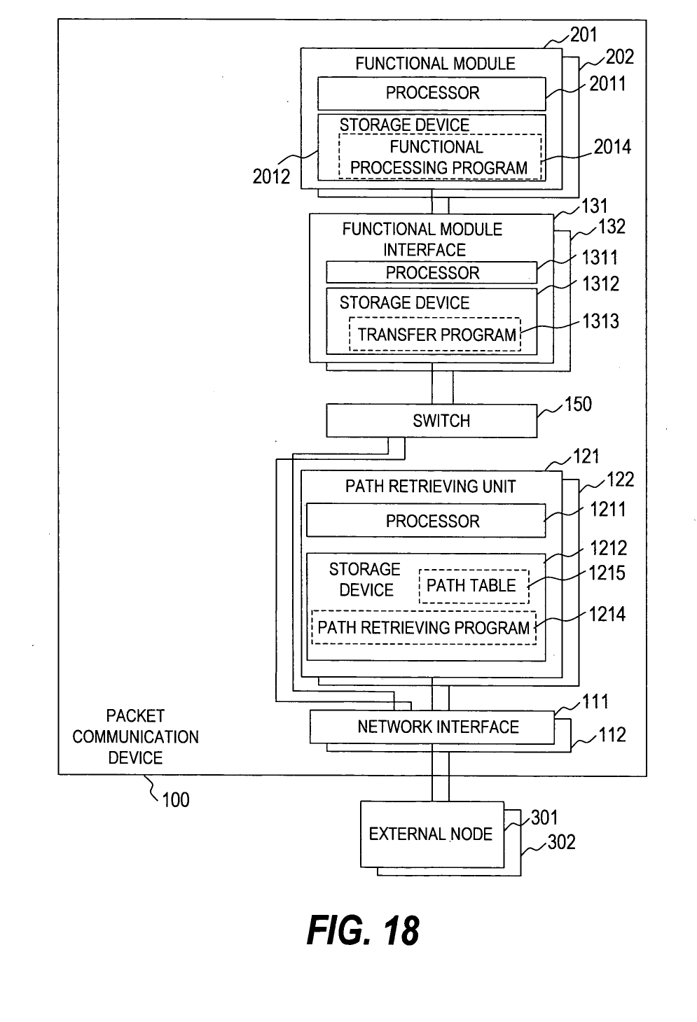

FIG. 18 is a block diagram of a packet communication device 100 in a fourth embodiment of this invention.

The packet communication device 100 includes network interfaces 111 and 112, path retrieving units 121 and 122, functional module interfaces 131 and 132, functional modules 201 and 202, and a switch 150.

The network interfaces 111 and 112, the functional modules 201 and 202, and the switch 150 are identical with those in the packet communication device as shown in FIG. 10 in the second embodiment. Thus, the identical components are denoted by the identical reference numerals. Explanations of the components are omitted.

The path retrieving units 121 and 122 include the processors 1211 and the storage devices 1212.

The processors 1211 execute programs stored in the storage devices 1212 to thereby perform various kinds of processing. The path tables 1215 and the path retrieving programs 1214 are stored in the storage devices 1212.

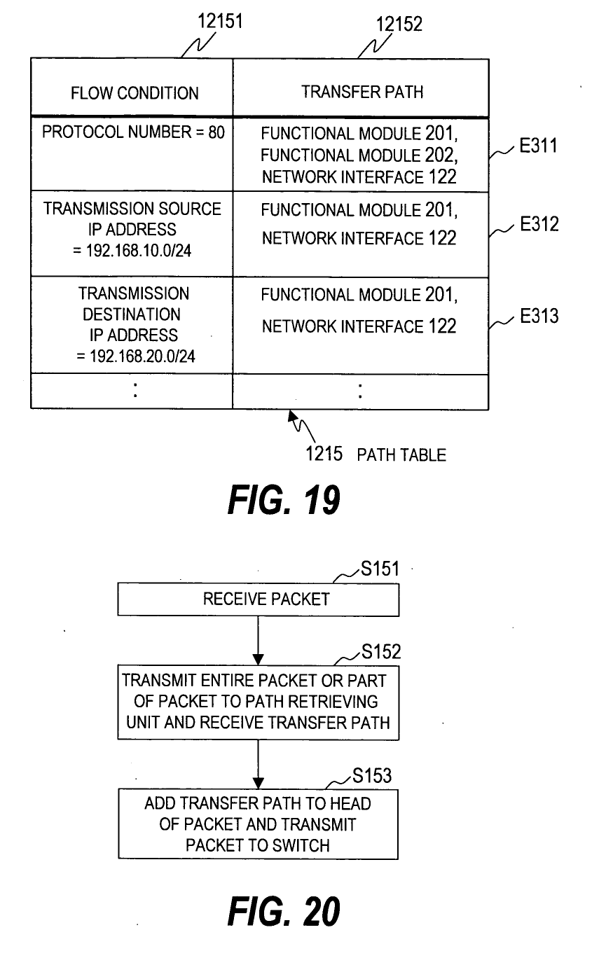

The path tables 1215 indicate transfer paths of packets received by the network interfaces 111 and 112. The path table 1215 is described later with reference to FIG. 19. The path retrieving programs 1214 retrieve the transfer paths of the packets received by the network interfaces 111 and 112 based on the path tables 1215.

The functional module interfaces 131 and 132 include processors 1311 and storage devices 1312.

The processors 1311 execute programs stored in the storage devices 1312 to thereby perform various kinds of processing. The transfer programs 1313 is stored in the storage device 1312.

The transfer programs 1313 process packets received from the functional modules 201 and 202 or the switch 150. The transfer programs 1313 transfers the packets.

FIG. 19 is a diagram of the path table 1215 of the path retrieving unit 121 and 122 in the fourth embodiment to this invention.

The path table 1215 includes a flow condition 12151 and a transfer path 12152.

The flow condition 12151 is a condition for judging a transfer path of packets received by the network interfaces 111 and 112.

The transfer path 12152 is a path for transferring the packet. Hardware identifiers of apparatuses to which the packet is transferred are stored in the transfer path 12152 from the head in an order of transfer.

For example, a packet with a protocol number “80” is transferred to the functional module 201, the functional module 202, and the network interface 112 in this order (entry E311). Similarly, a packet with a transmission source IP address “192.168.10.0/24” is transferred to the functional module 201 and the network interface 112 in this order (entry E312). A packet with a transmission source IP address “192.168.20.0/24” is transferred to the functional module 202 and the network interface 112 in this order (entry E313).

FIG. 20 is a flowchart of packet transfer processing of the network interface 111 according to the fourth embodiment of this invention.

First, the network interface 111 receives a packet from the external node 301 (S151).

Subsequently, the network interface 111 transmits the entire packet received or a part of the packet to the path retrieving unit 121. A section for judging a path of the packet (e.g., header section) has to be included in a part of the packet.

The path retrieving unit 121 retrieves an entry in which the received packet corresponds to the flow condition 12151 from the path table 12153. Subsequently, the path retrieving unit 121 extracts the transfer path 12152. When there are hardware identifiers included in the transfer path 12152, all of the hardware identifiers are extracted.

The path retrieving unit 121 transmits the transfer path 12152 retrieved to the network interface 111.

The network interface 111 receives the transfer path 12152 (S152).

Subsequently, the network interface 111 counts the number of hardware identifiers included in the transfer path 12152 received. The network interface 111 adds the received transfer path 12152 to the head of the packet received from the external node 301. The network interface 111 further adds the number of the hardware identifiers counted to the packet as a stack number counter. The stack number counter indicates the number of the hardware identifiers added to the packet.

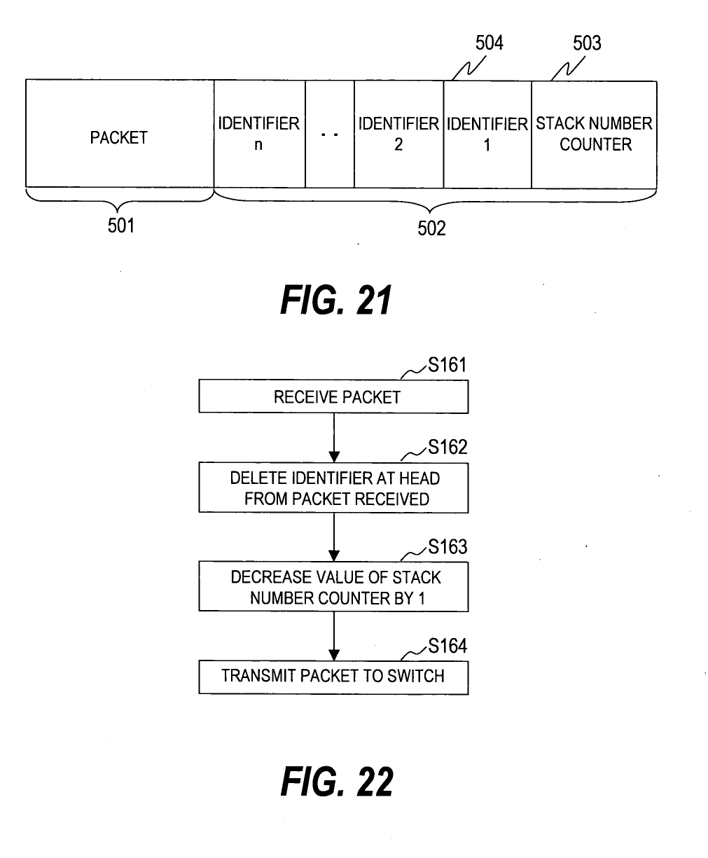

Consequently, the packet received from the external node 301 is changed as shown in FIG. 21.

The network interface 111 transmits the packet added with the transfer path 12152 and the stack number counter to the switch 150 (S153).

FIG. 21 is a diagram for explaining a packet inside the packet communication device 100 in the forth embodiment of this invention.

The packet inside the packet communication device 100 is obtained by adding an internal header section 502 to a packet 501 received from the external node 301.

The internal header section 502 includes a stack number counter 503 and a hardware identifier 504.

The hardware identifier 504 is an identifier for uniquely identifying an apparatus to which the packet is transferred. When there are plural apparatuses to which the packet is transferred, the packet includes the hardware identifiers 504 of all the apparatuses to which the packet is transferred.

The stack number counter 503 indicates the number of hardware identifiers 504 added to the packet.

FIG. 22 is a flowchart of packet transfer processing of the functional module interface 131 that receives a packet from the functional module 201 according to the fourth embodiment of this invention.

First, the functional module interface 131 receives a packet from the functional module 201 (S161).

Subsequently, the functional module interface 131 deletes a hardware identifier added to the head of the packet received (S162).

Subsequently, the functional module interface 131 reduces a value of a stack number counter added to the received packet (S163).

The functional module interface 131 transmits the packet to the switch 150 (S164).

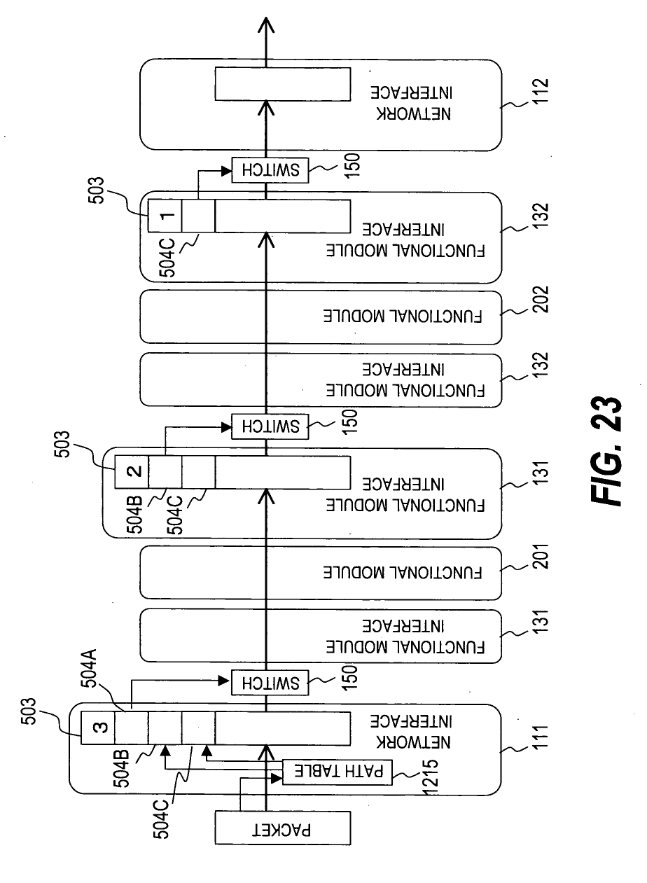

FIG. 23 is a diagram for explaining packet transfer processing of the packet communication device 100 according to the fourth embodiment of this invention.

First, the network interface 111 receives a packet from the external node 301. In this explanation, a protocol number of the packet received is “80”.

Subsequently, the network interface 111 transmits a header section of the received packet to the path retrieving unit 121.

The path retrieving unit 121 retrieves an entry in which the received packet corresponds to the path table 1215 of the flow condition 12151 from the path table 1215.

Subsequently, the path retrieving unit 121 extracts the transfer path 12152 from the entry retrieved. The path retrieving unit 121 transmits the transfer path 12152 retrieved to the network interface 111.

Specifically, since the protocol number of the packet is “80”, the path retrieving unit 121 retrieves an entry E311 from the path table 1215. The path retrieving unit 121 extracts the “functional module 201”, the “functional module 202”, and the “network interface 112” of the transfer path 12152 from the entry E311 and transmits the “functional module 201”, the “functional module 202”, and the “network interface 112” to the network interface 111.

The network interface 111 counts the number of hardware identifiers included in the transfer path 12152 received.

Subsequently, the network interface 111 adds the received transfer path 12152 to the packet. The network interface 111 also adds the number of the hardware identifiers counter to the packet as the stack number counter 503.

Specifically, the network interface 111 adds the “functional module 201”, the “functional module 202”, and the “network interface 112” of the transfer path 12152 to the packet as the hardware identifiers 504.

In this explanation, the “functional module 201” added to the packet is set as a hardware identifier 504A. Similarly, the “functional module 202” is set as a hardware identifier 504B. The “network interface 112” is set as a hardware identifier 504C.

Moreover, the network interface 111 adds the number “3” of the hardware identifiers included in the transfer path 12152 to the packet as the stack number counter 503.

The network interface 111 transmits the packet to the switch 150.

The switch 150 extracts the hardware identifier 504 added to the head from the packet received. The switch 150 transfers the received packet to an apparatus corresponding to the head of the hardware apparatus 504.

Specifically, the switch 150 extracts the “functional module 201” of the hardware identifier 504A added to the head from the received packet. The switch 150 transfers the received packet to the functional module interface 131 to which the “functional module 201” of the hardware identifier 504A extracted is connected.

The functional module interface 131 transfers the packet received from the switch 150 to the functional module 201 to which the functional module interface 131 is connected.

The functional module 201 receives a packet from the functional module interface 131. Subsequently, the functional module 201 executes the functional processing program 2014 to thereby apply predetermined processing to the packet received.

The functional module 201 transmits the packet to the functional module interface 131 to which the functional module 201 is connected.

The functional module interface 131 deletes the hardware identifier 504 added to the head of the packet from the packet received. Subsequently, the functional module interface 131 reduces a value of the stack number counter 503 added to the packet.

Specifically, the functional module interface 131 deletes the “functional module 201” of the hardware identifier 504A added to the head from the received packet. Subsequently, the functional module interface 131 changes “3” of the stack number counter 503 added to the packet to “2”.

The functional module interface 131 transmits the packet processed to the switch 150.

The switch 150 transfers the packet in the same manner as the processing at the time when the switch 150 receives a packet from the network interface 111.

Specifically, the switch 150 extracts the “functional module 202” of the hardware identifier 504B added to the head from the packet received. The switch 150 transfers the received packet to the functional module interface 132 to which the “functional module 202” of the hardware identifier 504B extracted is connected.

The functional module interface 132 transfers the packet received from the switch 150 to the functional module 202 to which the functional module interface 132 is connected.

The functional module 202 receives the packet. Next, the functional module 202 executes the functional processing program 2014 to thereby apply predetermined processing to the packet received.

The functional module 202 transmits the packet to the functional module interface 132 to which the functional module 202 is connected.

The functional module interface 132 processes the packet received in the same manner as the processing of the functional module interface 131.

Specifically, the functional module interface 132 deletes the “functional module 202” of the hardware identifier 504B added to the head from the received packet. Subsequently, the functional module interface 132 changes “2” of the stack number counter 503 added to the packet to “1,”.

The functional module interface 131 transmits the packet processed to the switch 150.

The switch 150 transfers the packet in the same manner as the processing at the time when the switch 150 receives a packet from the network interface 111.

Specifically, the switch 150 extracts the “network interface 112” of the hardware identifier 504C added to the head from the packet received. The switch 150 transfers the received packet to the network interface 112 of the hardware identifier 504C extracted.

The network interface 112 receives the packet from the switch 150. Subsequently, the network interface 112 removes the stack number counter 503 and the hardware identifier 504 from the packet received.

The network interface 112 transmits the packet, from which the stack number counter 503 and the hardware identifier 504 are removed, to the external node 302 to which the network interface 112 is connected.

### Fifth Embodiment

In a fifth embodiment of this invention, a packet inside the packet communication device 100 includes hardware identifiers of apparatuses to which the packet is transferred.

Since the packet communication device 100 in the fifth embodiment of this invention is identical with that in the fourth embodiment as shown in FIG. 18, an explanation of the packet communication device 100 is omitted.

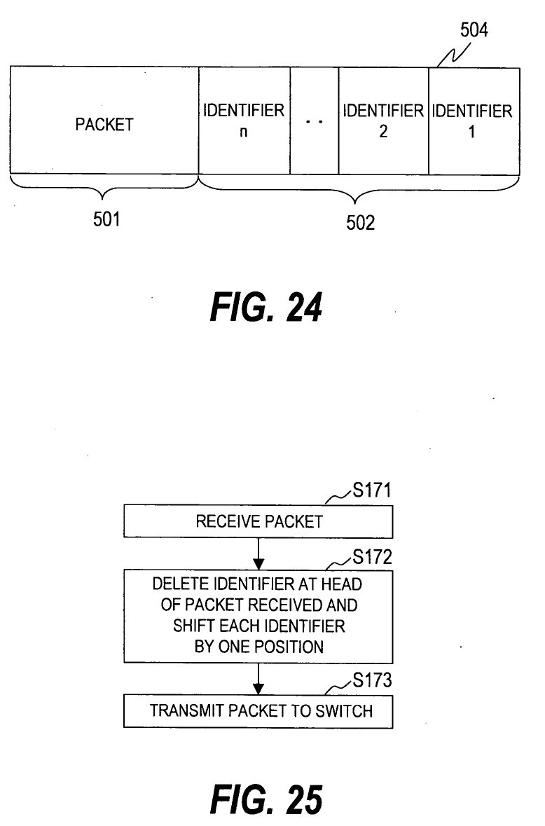

FIG. 24 is a diagram for explaining a packet inside the packet communication device 100 according to the fifth embodiment of this invention.

The packet inside the packet communication device 100 is obtained by adding the internal header section 502 to the packet 501 received from the external node 301.

The internal header section 502 includes N hardware identifiers 504. The hardware identifiers 504 are identifiers for uniquely identifying apparatuses to which the packet is transferred. The number of the hardware identifiers 504 (e.g., N) included in the internal header section 502 is set by an administrator or the like in advance.

When there are plural apparatuses to which the packet is transferred, the packet includes the hardware identifiers 504 of all the apparatuses to which the packet is transferred. When the number of apparatuses to which the packet is transferred is smaller than N, a dummy identifier is added to the packet to increase the number of the hardware identifiers 504 to N.

The packet cannot include the hardware identifiers 504 larger than N in number. In other words, in the packet communication device 100 in this embodiment, the number of functional modules 201 and 202 to which the packet is transferred is limited to N at the maximum.

FIG. 25 is a flowchart of packet transfer processing of the functional module interface 131 that receives a packet from the functional module 201 according to the fifth embodiment of this invention.

First, the functional module interface 131 receives a packet from the functional module 201 (S171).

Subsequently, the functional module interface 131 deletes a hardware identifier added to the head of the packet received. The functional module interface 131 shifts hardware identifiers added to a position second from the head and the subsequent positions by one position forward, respectively (S172). The functional module interface 131 adds a dummy identifier to the end of the hardware identifiers added to the packet.

The functional module interface 131 transmits the packet to the switch 150 (S173).

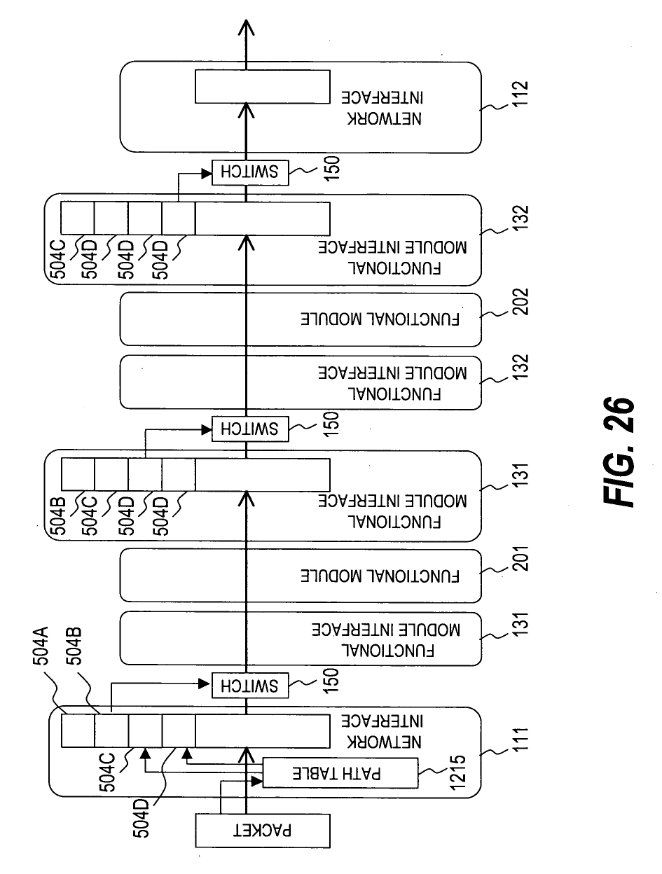

FIG. 26 is a diagram for explaining packet transfer processing of the packet communication device 100 according to the fifth embodiment of this invention.

First, the network interface 111 receives a packet from the external node 301. In this explanation, a protocol number of the packet received is “80”.

Subsequently, the network interface 111 transmits a header section of the received packet to the path retrieving unit 121.

The path retrieving unit 121 retrieves an entry in which the received header section corresponds to the flow condition 12151 of the path table 1215 from the path table 1215 as shown in FIG. 19.

Subsequently, the path retrieving unit 121 extracts the transfer path 12152 from the entry retrieved. The path retrieving unit 121 transmits the transfer path 12152 extracted to the network interface 111.

Specifically, since the protocol number of the packet is “80”, the path retrieving unit 121 retrieves an entry E311 from the path table 1215. The path retrieving unit 121 extracts the “functional module 201”, the “functional module 202”, and the “network interface 112” of the transfer path 12152 from the entry E311. the path retrieving unit 121 transmits the “functional module 201”, the “functional module 202”, and the “network interface 112” to the network interface 111.

The network interface 111 counts the number of hardware identifiers included in the transfer path 12152 received. Subsequently, the network interface 111 subtracts the number of hardware identifiers counted from the number of the hardware identifiers 504 added to the packet (e.g., N=4). In this way, the network interface 111 calculates the number of dummy identifiers to be added to the packet.

Subsequently, the network interface 111 adds the transfer path 12152 received to the packet. The network interface 111 further adds the dummy identifiers of the number calculated to the packet.

Specifically, the network interface 111 adds the “functional module 201”, the “functional module 202”, and the “network interface 112” of the transfer path 12152 to the packet as the hardware identifiers 504.

The “functional module 201” added to the packet is set as the hardware identifier 504A. Similarly, the “functional module 202” is set as the hardware identifier 504B. The “network interface 112” is set as the hardware identifier 504C.

The network interface 111 further adds one dummy identifier 504D to the packet.

The network interface 111 transmits the packet to the switch 150.

The switch 150 extracts the hardware identifier 504 added to the head of the packet from the packet received. The switch 150 transfers the received packet to an interface of an apparatus corresponding to the hardware identifier 504 at the head extracted.

Specifically, the switch 150 extracts the “functional module 201” of the hardware identifier 504A added to the head from the packet received. The switch 150 transfers the received packet to the functional module interface 131 to which the “functional module 201” of the hardware identifier 504A extracted is connected.

The functional module interface 301 transfers the packet received from the switch 150 to the functional module interface 201 to which the functional module interface 301 is connected.

The functional module 201 then receives the packet from the functional module interface 131. Next, the functional module 201 executes the functional processing program 2014 to thereby apply predetermined processing to the packet received.

The functional module 201 transmits the packet processed to the functional module interface 131 to which the functional module 201 is connected.

Subsequently, the functional module interface 131 deletes the hardware identifier 504 added to the head of the received packet from the packet received. The functional module interface 131 shifts hardware identifiers 504 added to a position second from the head and the subsequent positions by one position forward, respectively. The functional module interface 131 adds a dummy identifier to the end of the hardware identifiers 504 added to the packet.

Specifically, the functional module interface 131 deletes the “functional module 201” of the hardware identifier 504A added to the head of the received packet from the packet received. Subsequently, the functional module interface 131 shifts the hardware identifiers 504B, 504C, and 504D added to a position second from the head and the subsequent positions by one position forward, respectively. The functional module interface 131 adds the dummy identifier 505D to the end of the hardware identifiers 504 added to the packet.

The functional module interface 131 transmits the packet processed to the switch 150.

The switch 150 transfers the packet in the same manner as the processing at the time when the switch 150 receives a packet from the network interface 111.

Specifically, the switch 150 extracts the “functional module 202” of the hardware identifier 504B added to the head from the packet received. The switch 150 transfers the received packet to the functional module interface 132 to which the “functional module 202” of the hardware identifier 504B extracted is connected.

The functional module interface 132 transfers the packet received from the switch 150 to the functional module 202 to which the functional module interface 132 is connected.

The functional module 202 thereby receives the packet. Next, the functional module 202 executes the functional processing program 2014 to thereby apply predetermined processing to the packet received.

The functional module 202 transmits the packet to the functional module interface 132 to which the functional module 202 is connected.

The functional module interface 132 processes the packet received in the same manner as the processing of the functional module interface 131 explained above.

Specifically, the functional module interface 132 deletes the “functional module 202” of the hardware identifier 504B added to the head from the packet received. Subsequently, the functional module interface 131 shifts the hardware identifiers 504C, 504D, and 504D added to a position second from the head and the subsequent positions by one position forward, respectively. The functional module interface 131 adds the dummy identifier 504D to the end of the hardware identifiers 504 added to the packet.

The functional module interface 131 transmits the packet processed to the switch 150.

The switch 150 transfers the packet in the same manner as the processing at the time when the switch 150 receives a packet from the network interface 111.

Specifically, the switch 150 extracts the “network interface 112” of the hardware identifier 504C added to the head from the packet received. The switch 150 transfers the received packet to the “network interface 112” of the hardware identifier 504C extracted.

The network interface 112 receives the packet from the switch 150. Subsequently, the network interface 112 removes the hardware identifier 504 from the packet received.

The network interface 112 transmits the packet, from which the hardware identifier 504 is removed, to the external node 302 to which the network interface 112 is connected.

### Sixth Embodiment

In a sixth embodiment of this invention, the packet communication device 100 replaces flow identifiers to be added to a packet.

It is possible to apply the sixth embodiment of this invention to the packet communication device 100 in both the first and the second embodiments. In this explanation, the sixth embodiment is applied to the packet communication device 100 in the first embodiment.

A constitution of the packet communication device 100 in the sixth embodiment is identical with that of the packet communication device in the first embodiment as shown in FIG. 1 except a constitution of the internal transfer destination table 2013 stored in the functional module 201. Thus, an explanation of the constitution of the packet communication device 100 is omitted.

In the following explanation, the flow definition table 1404 shown in FIG. 13 is created.

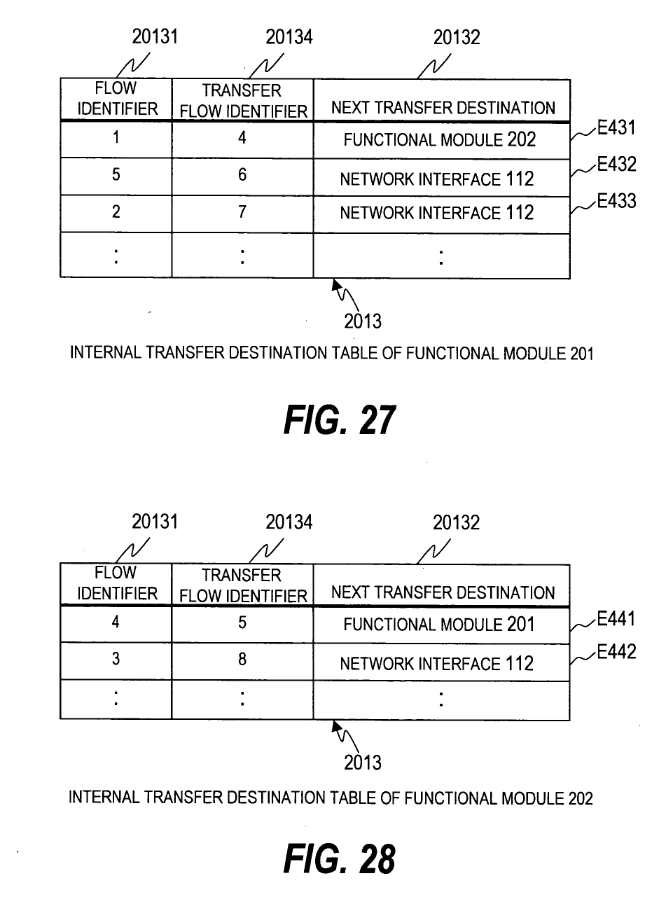

FIG. 27 is a diagram of the internal transfer destination table 2013 of the functional module 201 according to the sixth embodiment of this invention.

The internal transfer destination table 2013 in the functional module 201 includes components identical with those in the internal transfer destination table in the first embodiment as shown in FIG. 4. The identical components are denoted by the identical reference symbols. Explanations of the components are omitted. The internal transfer destination table 2013 further includes a transfer flow identifier 20134.

The transfer flow identifier 20134 is a flow identifier added to a packet processed by the functional module 201. In other words, when the functional module 201 receives a packet, the functional module 201 changes a flow identifier added to the packet to the flow identifier 20134.

FIG. 28 is a diagram of the internal transfer destination table 2013 of the functional module 202 according to the sixth embodiment of this invention.

Since components of the internal transfer destination table 2013 of the functional module 202 are identical with those of the internal transfer destination table as shown in FIG. 27 of the functional module 201, an explanation of the internal transfer destination table 2013 is omitted.

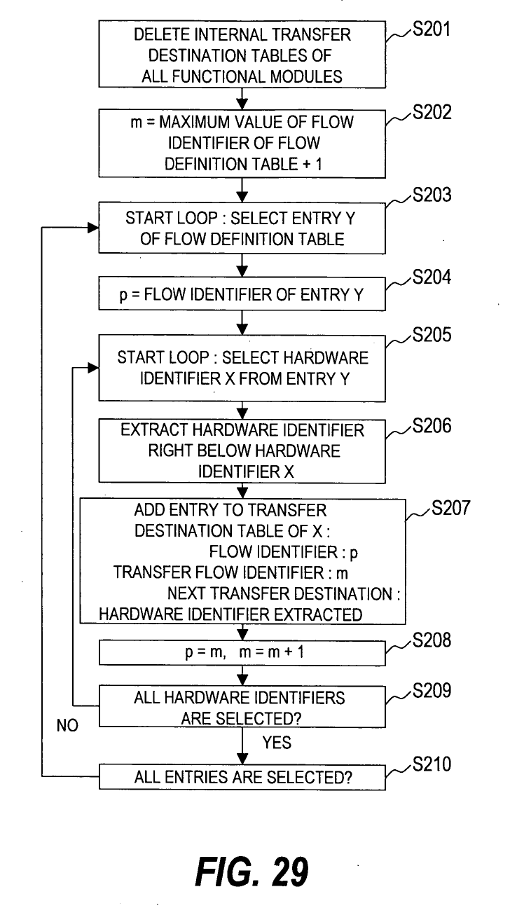

FIG. 29 is a flowchart of processing for creating the internal transfer destination table 2013 of the module control management unit 140 according to the sixth embodiment of this invention.

The processing for creating the internal transfer destination table 2013 is performed in step S104 of the path processing as shown in FIG. 6 of the module control management unit 140.

First, the module control management unit 140 deletes the internal transfer destination tables 2013 stored in all the functional modules 201 and 202 (S201).

Subsequently, the module control management unit 140 specifies a maximum value of the flow identifier 14042 of the flow definition table 1404. The module control management unit 140 sets a value obtained by adding 1 to the maximum value of the flow identifier 14042 of the flow definition table 1404 as m (S202).

For example, in the case of the flow definition table shown in FIG. 13, the module control management unit 140 sets “4” obtained by adding 1 to “3” of a maximum value 14042 of the flow identifier 1404 as m.

Subsequently, the module control management unit 140 selects entries Y of the flow definition table 1404 one by one from the head in order (S203). The module control management unit 140 applies the following processing to the entry Y selected.

First, the module control management unit 140 sets a value of the flow identifier 14042 of the selected entry Y to p (S204).

Subsequently, the module control management unit 140 selects hardware identifier stored in the transfer path 14043 of the selected entry Y one by one from the head in order (S205). One hardware identifier selected from the entry Y is assumed to be X. The module control management unit 140 applies the following processing to the selected hardware identifier X.

The module control management unit 140 extracts a hardware identifier stored right below the selected hardware identifier X from the transfer path 14043 of the selected entry Y (S206).

Subsequently, the module control management unit 140 adds a new entry to the internal transfer destination tables 2013 of the functional modules 201 and 202 with the hardware identifier X.

The module control management unit 140 stores p in the flow identifier 20131 of the new entry. The module control management unit 140 stores m in the transfer flow identifier 20134 of the new entry. The module control management unit 140 stores the hardware identifier extracted in step S206 in the next transfer destination of the new entry (S207).

The module control management unit 140 sets p as a value of m and adds 1 to m (S208).

The module control management unit 140 judges whether all hardware identifiers stored in the transfer path 14043 of the selected entry Y are selected (S209).

When all the hardware identifiers are not selected, the module control management unit 140 judges that creation of the internal transfer destination table 2013 concerning the entry Y is not completed. Thus, the module control management unit 140 returns to step S205 and repeats the processing for creating the internal transfer destination table 2013.

On the other hand, when all the hardware identifiers are selected, the module control management unit 140 judges that creation of the internal transfer destination table 2013 concerning the entry Y is completed. Thus, the module control management unit 140 judges whether all the entries of the flow definition table 1404 are selected (S210).

When all the entries are not selected, the module control management unit 140 judges that entries for which the internal transfer destination table 2013 is not created still remain. Thus, the module control management unit 140 returns to step S203 and repeats the processing for creating the internal transfer destination table 2013.

On the other hand, when all the entries are selected, the module control management unit 140 judges that creation of the internal transfer destination table 2013 concerning the flow definition table 1404 is completed and ends the processing.

As described above, the module control management unit 140 creates the internal transfer destination table 2013.

For example, the module control management unit 140 creates the internal transfer destination table 2013 of the functional module 201 shown in FIG. 27 based on the flow definition table 1404 shown in FIG. 13. Specifically, the module control management unit 140 creates entries E431 and E432 of the internal transfer destination table 2013 based on the entry E211 of the flow definition table 1404. The module control management unit 140 creates an entry E433 of the internal transfer destination table 2013 based on the entry E212 of the flow definition table 1404.

Similarly, the module control management unit 140 creates the internal transfer destination table 2013 of the functional module 202 shown in FIG. 28 based on the flow definition table 1404 shown in FIG. 13. Specifically, the module control management unit 140 creates an entry E441 of the internal transfer destination table 2013 based on the entry E211 of the flow definition table 1404. The module control management unit 140 creates an entry E442 of the internal transfer destination table 2013 based on the entry E213 of the flow definition table 1404.

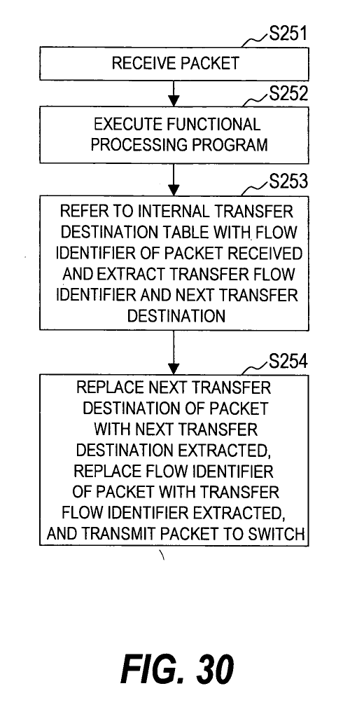

FIG. 30 is a flowchart of packet processing of the functional module 201 according to the sixth embodiment of this invention.

First, the functional module 201 receives a packet from the functional module interface 131 (S251). Subsequently, the functional module 201 executes the functional processing program 2014 to thereby apply predetermined processing to the packet received (S252).

Subsequently, the functional module 201 extracts a flow identifier added to the received packet. The functional module 201 selects, from the internal transfer destination table 2013, an entry in which the flow identifier extracted and the flow identifier 20131 of the internal transfer destination table 2013 coincide with each other.

The functional module 201 extracts the transfer flow identifier 20134 and the next transfer destination 20132 from the entry selected (S253).

The functional module 201 replaces the next transfer destination added to the received packet with the next transfer destination 20132 extracted. The functional module 201 replaces the flow identifier added to the received packet with the transfer flow identifier 20134.

The functional module 201 transmits the packet to the switch 150 via the functional module interface 131 (S254).

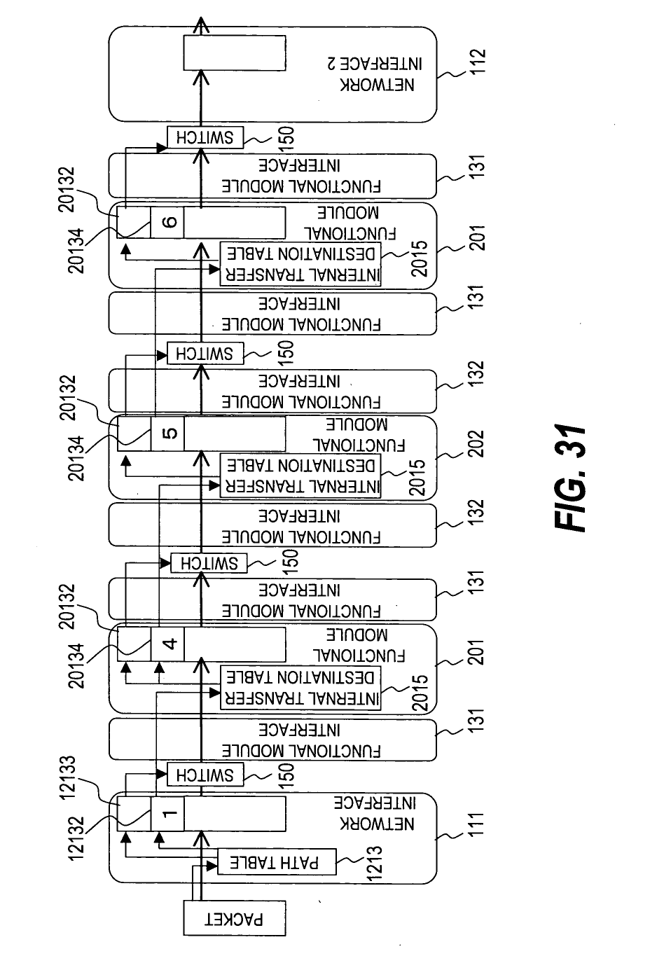

FIG. 31 is a diagram for explaining packet transfer processing of the packet communication device 100 according to the sixth embodiment of this invention.

First, the network interface 111 receives a packet from the external node 301. In this explanation, a protocol number of the packet received is “80”.

Subsequently, the network interface 111 transmits a header section of the received packet to the path retrieving unit 121. The path retrieving unit 121 retrieves an entry in which the header section received corresponds to the flow condition 12131 of the path table 1213 as shown in FIG. 3 from the path table 1213.

Subsequently, the path retrieving unit 121 extracts the flow identifier 12132 and the next transfer destination 12133 from the entry retrieved. The path retrieving unit 121 transmits the flow identifier 12132 and the next transfer destination 12133 extracted to the network interface 111.

Specifically, since the protocol number of the packet is “80”, the path retrieving unit 121 retrieves the entry E121 from the path table 1213. The path retrieving unit 121 extracts “1” of the flow identifier 12132 and the “functional module 201” of the next transfer destination 12133 from the entry E121 and transmits “1” and the “functional module 201” to the network interface 111.

The network interface 111 adds the flow identifier 12132 and the next transfer destination 12133 received to the packet. The network interface 111 transmits the packet to the switch 150.

The switch 150 adds the next transfer destination 12133 from the packet received. The switch 150 transfers the received packet to an interface of an apparatus corresponding to the next transfer destination 12133 extracted.

Specifically, the switch 150 extracts the “functional module 201” of the next transfer destination 12133 from the packet received. The switch 150 transfers the received packet to the functional module interface 131 to which the “functional module 201” of the next transfer destination 12133 extracted.

The functional module interface 131 transfers the packet received from the switch 150 to the functional module 201 to which the functional module interface 131 is connected.

The functional module 201 receives a packet from the functional module interface 131. Subsequently, the functional module 201 executes the functional processing program 2014 to thereby apply predetermined processing to the packet received.

Subsequently, the functional module 201 extracts the flow identifier 12132 added to the received packet. The functional module 201 retrieves, from the internal transfer destination table 2013 of the functional module 201, an entry in which the flow identifier 12132 extracted and the flow identifier 20131 of the internal transfer destination table 2013 coincide with each other.

Subsequently, the functional module 201 extracts the transfer flow identifier 20134 and the next transfer destination 20132 from the retrieved entry.

The functional module 201 replaces the next transfer destination 12133 added to the received packet with the next transfer destination 20132 extracted. Further, the functional module 201 replaces the flow identifier 12132 added to the received packet with the transfer flow identifier 20134 extracted.

Specifically, the functional module 201 extracts “1” of the flow identifier 12132 added to the received packet.

Subsequently, the functional module 201 retrieves, from the internal transfer destination table 2013 of the functional module 201, the entry E431 in which “1” of the flow identifier 12132 extracted and the flow identifier 20131 of the internal transfer destination table 2013 coincide with each other.

The functional module 201 extracts “4” of the transfer flow identifier 20134 and the “functional module 202” of the next transfer destination 20132 from the entry E431 retrieved.

The functional module 201 replaces the “functional module 201” of the next transfer destination 12133 added to the received packet with the “functional module 202” of the next transfer destination 20132 extracted. The functional module 201 replaces “1” of the flow identifier added to the received packet with “4” of the transfer flow identifier 20134 extracted.

The functional module 201 transmits the packet to the functional module interface 131 to which the functional module 201 is connected.

The functional module interface 131 transfers the packet received to the switch 150.

The switch 150 transfers the packet in the same manner as the processing performed when the switch 150 receives the packet from the network interface 111.

Specifically, the switch 150 extracts the “functional module 202” of the next transfer destination 20132 from the packet received. The switch 150 transfers the received packet to the functional module interface 132 to which the “functional module 202” of the next transfer destination 20132 extracted is connected.

The functional module interface 132 transfers the packet received from the switch 150 to the functional module 202 to which the functional module interface 132 is connected.

The functional module 202 processes the packet in the same manner as the processing performed by the functional module 201.

Specifically, the functional module 202 executes the functional processing program 2014 to thereby apply predetermined processing to the packet received.

Subsequently, the functional module 202 extracts “4” of the flow identifier added to the received packet.

Subsequently, the functional module 202 retrieves, from the internal transfer destination table 2013 of the functional module 202, the entry E441 in which “4” of the flow identifier extracted and the flow identifier 20131 of the internal transfer destination table 2013 coincide with each other.

The functional module 202 extracts “5” of the transfer flow identifier 20134 and the “functional module 201” of the next transfer destination 20132 from the entry E441 retrieved.

The functional module 202 replaces the “functional module 202” of the next transfer destination added to the received packet with the “functional module 201′ of the next transfer destination 20132 extracted. The functional module 202 replaces “4” of the flow identifier added to the received packet with “5” of the transfer flow identifier 20134 extracted.

The functional module 202 transmits the packet to the functional module interface 132 to which the functional module 202 is connected.

The functional module interface 132 transfers the packet received to the switch 150.

The switch 150 transfers the packet in the same manner as the processing performed when the switch 150 receives the packet from the network interface 111.

Specifically, the switch 150 extracts the “functional module 201” of the next transfer destination 20132 from the packet received. The switch 150 transfers the received packet to the functional module interface 131 to which the “functional module 201” of the next transfer destination 20132 extracted is connected.

The functional module interface 131 transfers the packet received from the switch 150 to the functional module 201 to which the functional module interface 131 is connected.

The functional module 201 processes the packet in the same manner as above.

Specifically, the functional module 201 executes the functional processing program 2014 to thereby apply predetermined processing to the packet received.

Subsequently, the functional module 201 extracts “5” of the flow identifier added to the received packet.

Subsequently, the functional module 201 retrieves, from the internal transfer destination table 2013 of the functional module 201, the entry E432 in which “5” of the flow identifier extracted and the flow identifier 20131 of the internal transfer destination table 2013 coincide with each other.

The functional module 201 extracts “6” of the transfer flow identifier 20134 and the “network interface 112” of the next transfer destination 20132 from the entry E432 retrieved.

The functional module 201 replaces the “functional module 201” of the next transfer destination 20132 added to the received packet with the “network interface 112” of the next transfer destination 20132 extracted. Then, the functional module 201 replaces “5” of the flow identifier added to the received packet with “6” of the transfer flow identifier 20134 extracted.

The functional module 201 transmits the packet to the functional module interface 131 to which the functional module 201 is connected.

The functional module interface 131 transfers the packet received to the switch 150.

The switch 150 transfers the packet in the same manner as the processing performed when the switch 150 receives the packet from the network interface 111.

Specifically, the switch 150 extracts the “network interface 112” of the next transfer destination 20132 from the packet received. The switch 150 transfers the received packet to the network interface 112 of the next transfer destination 20132 extracted.

The network interface 112 receives the packet from the switch 150. Subsequently, the network interface 112 removes the transfer flow identifier 20134 and the next transfer destination 20132 from the packet received.

The network interface 112 transmits the packet, from which the transfer flow identifier 20134 and the next transfer destination 20132 are removed, to the external node 302 to which the network interface 112 is connected.

### Seventh Embodiment

In a seventh embodiment of this invention, the functional modules 201 and 202 in the third embodiment include the plural functional processing programs 2014.

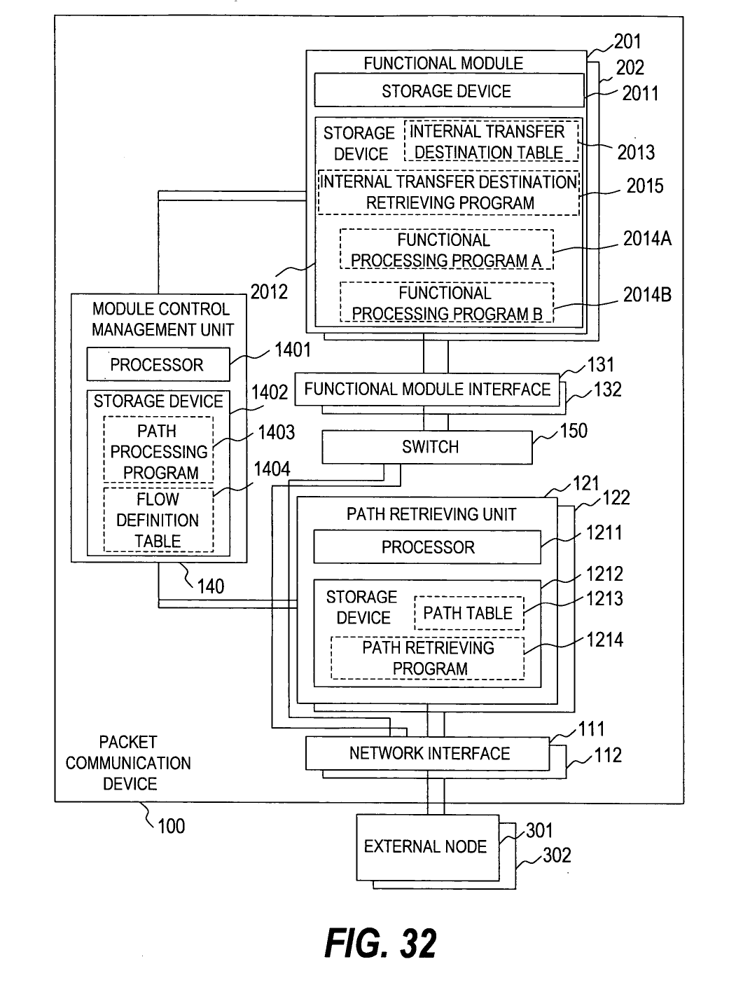

FIG. 32 is a block diagram of a packet communication device 100 in a seventh embodiment of this invention.

The packet communication device 100 in the seventh embodiment has a constitution identical with that of the packet communication device as shown in FIG. 1 in the third embodiment except that the functional modules 201 and 202 include plural functional processing programs. Components identical with those in the packet communication device in the third embodiment are denoted by the identical reference symbols. Explanations of the components are omitted.

The functional module 201 includes a functional processing program A 2014A and a functional processing program B 2014B. Each of the functional modules 201 and 202 may include two or more functional processing programs 2014.

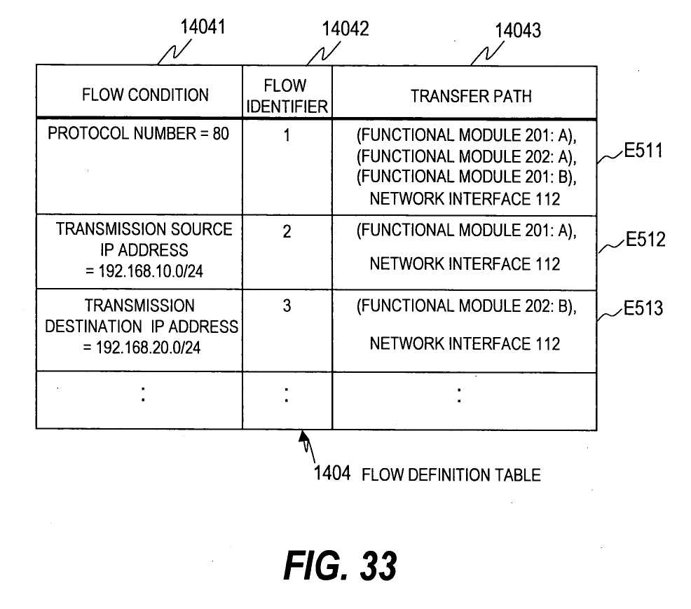

In an example explained below, the flow definition table 1404 shown in FIG. 33 is created.

FIG. 33 is a diagram of the flow definition table 1404 of the module control management unit 140 according to the seventh embodiment of this invention.

The flow definition table 1404 in the seventh embodiment includes components identical with those in the flow definition table as shown in FIG. 13 in the third embodiment. The identical components are denoted by the identical reference symbols. Explanations of the components are omitted.

In the transfer path 14043 of the flow definition table 1404 in the seventh embodiment, in addition to a path through which a packet is transferred, a processing content for the packet is stored. The processing content is, for example, an identifier of the functional processing program 2014 for processing the packet.

For example, a packet with a protocol number “80” is transferred to the functional module 201 and processed by the functional processing program A 2014A of the functional module 201. Subsequently, the packet is transferred to the functional module 202 and processed by the functional processing program A 2014A of the functional module 202. The packet is transferred to the functional module 201 and processed by the functional processing program B 2014B of the functional module 201. The packet is transferred to the network interface 112 (an entry E511).

A packet with a transmission source IP address “192.168.10.0/24” is transferred to the functional module 201 and processed by the functional processing program A 2014A of the functional module 201. The packet is transferred to the network interface 112 (an entry E512).

Further, a packet with a transmission source IP address 192.168.20.0/24” is transferred to the functional module 202 and processed by the functional processing program B 2014B of the functional module 202. The packet is transferred to the network interface 112 (an entry E513).

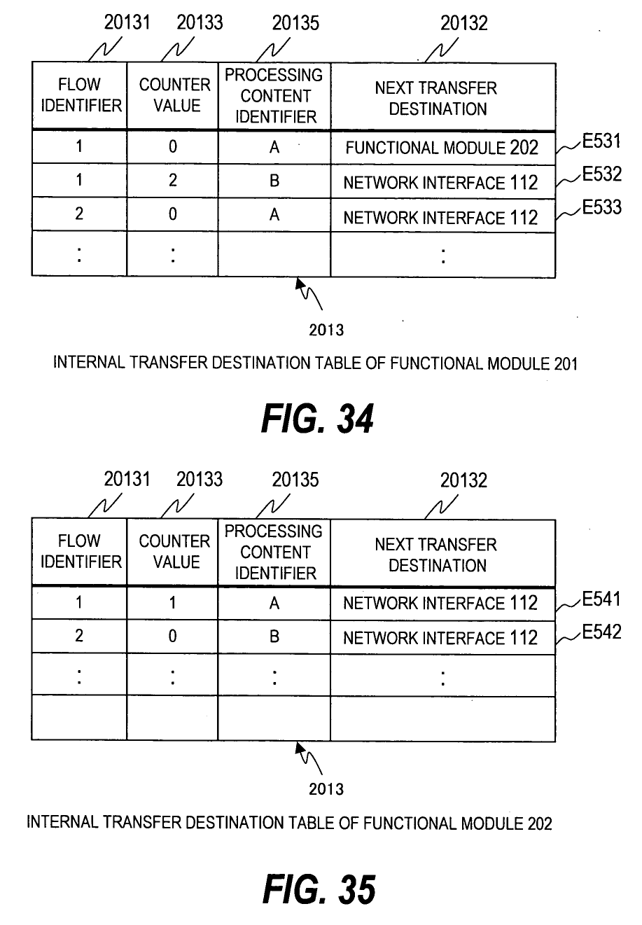

FIG. 34 is a diagram of the internal transfer destination table 2013 of the functional module 201 according to the seventh embodiment of this invention.

The internal transfer destination table 2013 of the functional module 201 includes components identical to those of the internal transfer destination table as shown in FIG. 14 in the third embodiment. The identical components are denoted by the identical reference symbols.

Explanations of the Components are Omitted

The internal transfer destination table 2013 in the seventh embodiment further includes a processing content identifier 20135.

The processing content identifier 20135 is an identifier for uniquely identifying the functional program 2014 for processing the packet.

Subsequently, a process in which the module control management unit 140 creates the internal transfer destination tables 2013 of the functional modules 201 and 202 having hardware identifiers X will be explained.

First, the module control management unit 140 retrieves the hardware identifiers X from the transfer path 14043 of the flow definition table 1404. Then, the module control management unit 140 creates one entry of the internal transfer destination table 2013 based on one of the hardware identifiers X retrieved.

The module control management unit 140 extracts, from the flow definition table 1404, the flow identifier 14042 of an entry in which the hardware identifier X retrieved is stored. Subsequently, the module control management unit 140 stores the flow identifier 14042 extracted in the flow identifier 20131 of the internal transfer destination table 2013.

The module control management unit 140 extracts a hardware identifier stored right below the retrieved hardware identifier X from the transfer path 14043 of the flow definition table 1404. The module control management unit 140 stores the hardware identifier extracted in the next transfer destination 20132 of the internal transfer destination table 2013.

The module control management unit 140 selects, from the flow definition table 1404, an entry in which the retrieved hardware identifier X is stored. The module control management unit 140 counts, in the entry selected, the number of hardware identifiers stored on the retrieved hardware identifier X. The module control management unit 140 stores the value counted in the counter value 20133 of the internal transfer destination table 2013.

The module control management unit 140 extracts a processing content stored in association with the retrieved hardware identifier X from the transfer path 14043 of the flow definition table 1404. The module control management unit 140 stores the processing content extracted in the processing content identifier 20135 of the internal transfer destination table 2013.

The module control management unit 140 creates the internal transfer destination table 2013 of the functional module 201 shown in FIG. 34 based on the flow definition table 1404 shown in FIG. 33.

Specifically, the module control management unit 140 creates entries E531 and E532 of the internal transfer destination table 2013 based on the entry E511 of the flow definition table 1404. The module control management unit 140 creates an entry E533 of the internal transfer destination table 2013 based on the entry E512 of the flow definition table 1404.

FIG. 35 is a diagram of the internal transfer destination table 2013 of the functional module 202 according to the seventh embodiment of this invention.

Since components of the internal transfer destination table 2013 of the functional module 202 are identical with those of the internal transfer destination table as shown in FIG. 34 of the functional module 201, an explanation of the internal transfer destination table 2013 is omitted.

The module control management unit 140 creates the internal transfer destination table 2013 of the functional module 202 shown in FIG. 35 based on the flow definition table 1404 shown in FIG. 13.

Specifically, the module control management unit 140 creates an entry E541 of the internal transfer destination table 2013 based on the entry E511 of the flow definition table 1404. The module control management unit 140 creates an entry E542 of the internal transfer destination table 2013 based on the entry E513 of the flow definition table 1404.

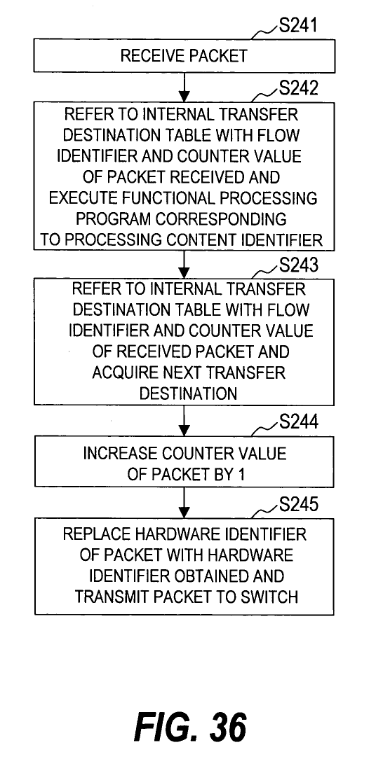

FIG. 36 is a flowchart of packet processing of the functional module 201 according to the seventh embodiment of this invention.

First, the functional module 201 receives a packet from the functional module interface 131 (S241).

Subsequently, the functional module 201 extracts a flow identifier added to the packet received and a value of a counter. The functional module 201 selects, from the internal transfer destination table 2013, an entry in which the flow identifier extracted and the flow identifier 20131 of the internal transfer destination table 2013 coincide with each other and the counter value extracted and the counter value 20133 of the internal transfer destination table 2013 coincide with each other.

The functional module 201 extracts the processing content identifier 20135 from the entry selected. The functional module 201 executes the functional processing program 2014 corresponding to the processing content identifier 20135 extracted to thereby apply predetermined processing to the received packet (S242).

The functional module 201 extracts the next transfer destination 20132 from the selected entry (S243).

The functional module 201 increases the value of the counter added to the received packet (S244).

The functional module 201 replaces a next transfer destination added to the received packet with the next transfer destination 20132 extracted. The functional module 201 transmits the packet to the switch 150 via the functional module interface 131 (S245).

The other devices constituting the packet communication device 100 performs processing identical with that in the third embodiment. Thus, explanations of the devices are omitted.

### Eighth Embodiment

In an eighth embodiment of this invention, each of the functional modules 201 and 202 in the fourth embodiment include plural functional processing programs 2014.

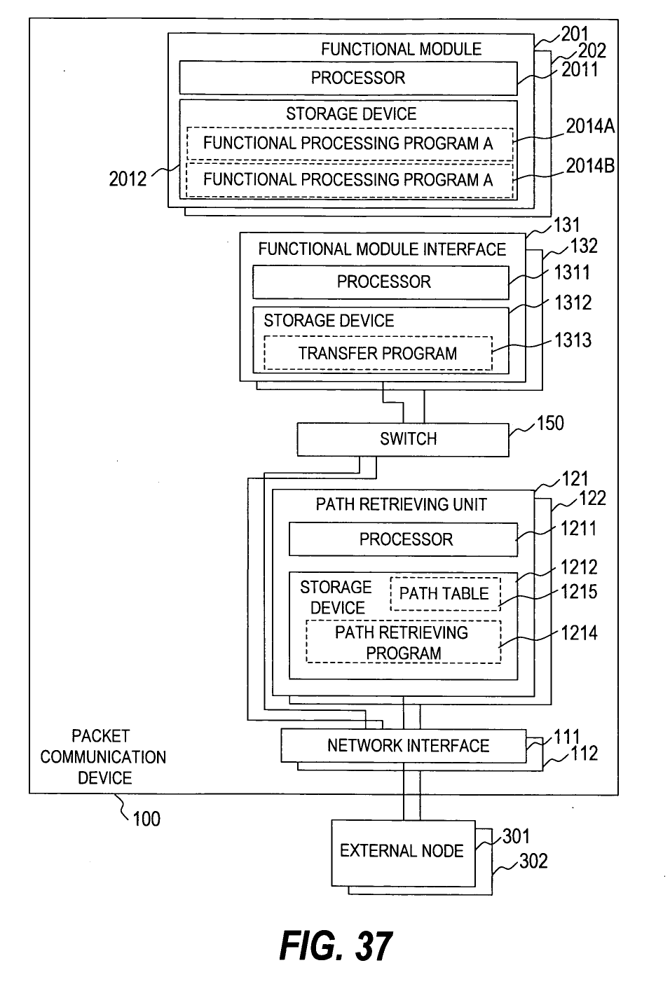

FIG. 37 is a block diagram of the packet communication device 100 in an eighth embodiment of this invention.

The packet communication device 100 in the eighth embodiment has a constitution identical with that in the fourth embodiment as shown in FIG. 18 except that each of the functional modules 201 and 202 include plural functional processing programs. Components identical with those in the packet communication device in the fourth embodiment are denoted by the identical reference symbols. Explanations of the components are omitted.

The functional module 201 includes the functional processing program A 2014A and the functional processing program B 2014B. Each of the functional modules 201 and 202 may include two or more functional processing programs 2014.

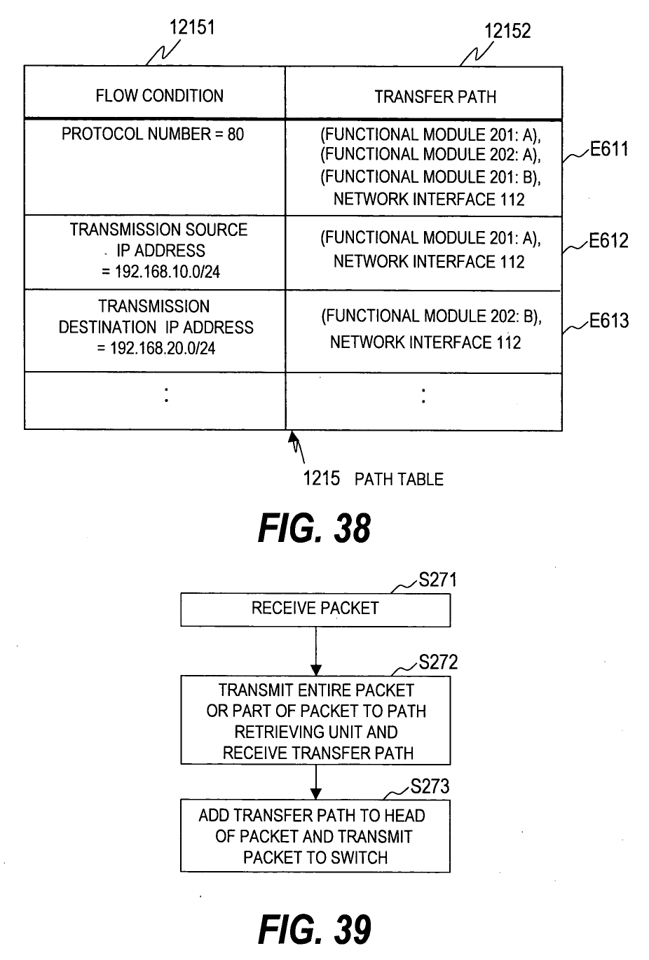

FIG. 38 is a diagram of the path table 1215 of the path retrieving units 121 and 122 according to the eighth embodiment of this invention.

The path table 1215 in the eighth embodiment includes components identical with those in the path table as shown in FIG. 19 in the fourth embodiment. The identical components are denoted by the identical reference symbols. Explanations of the components are omitted.

In a transfer path 12152 of the path table 1215 in the eighth embodiment, in addition to a path through which a packet is transferred, a processing content for the packet is stored. The processing content is, for example, an identifier of the functional processing program 2014 for processing the packet.

FIG. 39 is a flowchart of packet transfer processing of the network interface 111 according to the eighth embodiment of this invention.

First, the network interface 111 receives a packet from the external node 301 (S271).

Subsequently, the network interface 111 transmits the entire packet received or a part of the packet to the path retrieving unit 121. A section for judging a path of the packet (e.g., header section) has to be included in the part of the packet.

The path retrieving unit 121 retrieves an entry in which the received packet corresponds to the flow condition 12151 from the path table 1215. Subsequently, the path retrieving unit 121 extracts the transfer path 12152 from the entry retrieved.

A hardware identifier and a processing content corresponding to the hardware identifier are included in the transfer path 12152. The processing content corresponding to the hardware identifier is, for example, an identifier for uniquely identifying the functional processing program 2014 executed by the functional modules 201 and 202 with the hardware identifier.

The path retrieving unit 121 transmits the transfer path 12152 retrieved to the network interface 111.

The network interface 111 receives transfer path 12152 (S272).

Subsequently, the network interface 111 counts the number of hardware identifiers included in the transfer path 12152 received. The network interface 111 adds the received transfer path 12152 to the head of the packet received from the external node 301. The network interface 111 further adds the number of the hardware identifiers counted to the packet as a stack number counter. The stack number counter indicates the number of the hardware identifiers added to the packet.

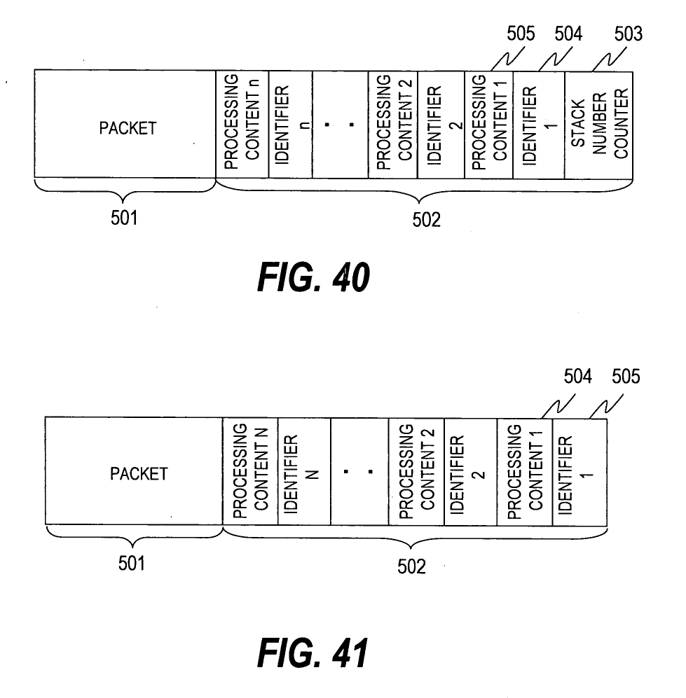

Consequently, the packet received from the external node 301 is changed as shown in FIG. 40.

The network interface 111 transmits the packet to which the transfer path 12152 and the stack number counter are added to the switch 150 (S273).

The other devices constituting the packet communication device 100 perform processing identical with that in the fourth embodiment. Thus, explanations of the devices are omitted.

FIG. 40 is a diagram for explaining a packet inside the packet communication device 100 according to the eighth embodiment of this invention.

The packet inside the packet communication device 100 is obtained by adding the internal header section 502 to the packet 501 received from the external node 301.

The internal header section 502 includes the stack number counter 503, the hardware identifier 504, and a processing content 505.

The hardware identifier 504 is an identifier for uniquely identifying an apparatus to which the packet is transferred. When there are plural apparatuses to which the packet is transferred, the packet includes the hardware identifiers 504 of all the apparatuses to which the packet is transferred.

The processing content 505 is associated with the hardware identifier 504. An identifier for uniquely identifying the functional processing program 2014 executed by an apparatus with the associated hardware identifier 504 is stored in the processing content 505.

The stack number counter 503 indicates the number of hardware identifiers 504 added to the packet.

It is also possible to apply this embodiment to the fifth embodiment.

In this case, a stack number counter is not added to a packet in the step S273 of the packet transfer processing as shown in FIG. 39 of the network interface 111.

The network interface 111 changes the received packet to an internal packet shown in FIG. 41.

FIG. 41 is a diagram for explaining a packet inside the packet communication device 100 according to the eighth embodiment of this invention.

The packet inside the packet communication device 100 is obtained by adding the internal header section 502 to the packet 501 received from the external node 301.

The internal header section 502 includes N hardware identifiers 504 and N processing contents 505. Constitutions of the hardware identifier 504 and the processing content 505 are identical with those in the packet as shown in FIG. 40. Thus, explanations of the hardware identifier 504 and the processing content 505 are omitted.

When there are plural apparatuses to which the packet is transferred, the packet includes the hardware identifiers 504 and the processing contents 505 of all the apparatuses. When the number of the apparatuses to which the packet is transferred is smaller than N, a dummy identifier is added to the packet to increase the number of the hardware identifier 504 to N. Similarly, dummy processing contents equivalent in number to dummy identifiers are added to the packet to increase the number of processing contents to N.

The packet cannot include the hardware identifiers 504 larger than N in number. In other words, in the packet transfer apparatus 100, the number of functional modules 201 and 202 to which the packet is transferred is limited to N at the maximum.

It is possible to apply this invention to a communication apparatus that transfers a packet on a network.

While the present invention has been described in detail and pictorially in the accompanying drawings, the present invention is not limited to such detail but covers various obvious modifications and equivalent arrangements, which fall within the purview of the appended claims.

What is claimed is:

1. A packet communication device that receives a packet from a network and transmits the received packet to the network, the packet communication device comprising:
a network interface for transmitting the packet to and receiving the packet from the network;
a path retrieving unit for judging a transfer order, based on which the received packet is transferred in the packet communication device, on the basis of the received packet and giving an identifier indicating the transfer order judged to the packet;
a functional module interface to which a functional module that applies predetermined processing to the packet is connected;
a module management unit for managing the functional module; and
a switch for connecting the network interface and the functional module interface.

2. The packet communication device according to claim 1, wherein the identifier has a fixed length.

3. The packet communication device according to claim 1, wherein the packet communication device includes a plurality of the functional module interfaces.

4. The packet communication device according to claim 1, wherein the functional module comprises an internal transfer destination retrieving unit for determining a transfer destination in the packet communication device on the basis of the identifier given to the packet by the path retrieving unit.

5. The packet communication device according to claim 1, wherein the functional module interface comprises an internal transfer destination retrieving unit for determining a transfer destination in the packet communication device on the basis of the identifier given to the packet by the path retrieving unit.

6. The packet communication device according to claim 1, further comprising an identifier converting unit for changing the identifier given by the path retrieving unit.

7. The packet communication device according to claim 6, wherein the identifier converting unit comprises identifier change information indicating a relation between the identifier before the change and the identifier after the change and changes the identifier on the basis of the identifier change information.

8. The packet communication device according to claim 6, wherein the identifier converting unit changes the identifier in accordance with a predetermined rule.

9. The packet communication device according to claim 1, wherein the path retrieving unit judges a content of processing applied to the packet by the functional module on the basis of the received packet and gives a processing content identifier indicating the processing content judged to the packet.

10. A packet communication device that receives a packet from a network and transmits the received packet to the network, the packet communication device comprising:
a network interface for transmitting the packet to and receiving the packet from the network;
a path retrieving unit for judging a transfer order, based on which the received packet is transferred in the packet communication device, on the basis of the received packet and giving an identifier indicating the transfer order judged to the packet;
a functional module for applying predetermined processing to the packet;
a module management unit for managing the functional module; and
a switch for connecting the network interface and the functional module interface.

11. A packet communication device that receives a packet from a network and transfers the received packet to the network, the packet communication device comprising:
a network interface for transmitting the packet to and receiving the packet from the network;
a path retrieving unit for judging a transfer order, based on which the received packet is transferred in the packet communication device, on the basis of the received packet and giving the transfer order judged to the packet;
a functional module interface to which a functional module that applies predetermined processing to the packet is connected;
a module management unit for managing the functional module; and
a switch for connecting the network interface and the functional module interface,
wherein the functional module interface comprises an internal transfer destination retrieving unit that determines a transfer destination in the packet communication device on the basis of the transfer order given to the packet by the path retrieving unit.

12. The packet communication device according to claim 11, further comprising a functional module that is connected to the functional module interface.
